(19) United States
(12) Patent Application Publication
(10) Pub. No.: US 2026/0133517 A1
(43) Pub. Date: May 14, 2026

(54) TONER

(71) Applicant: CANON KABUSHIKI KAISHA, Tokyo (JP)

(72) Inventors: JUNICHI TAMURA, Ibaraki (JP); TAKESHI HASHIMOTO, Ibaraki (JP); MEGUMI SHINO, Chiba (JP); HAYATO IDA, Ibaraki (JP)

(21) Appl. No.: 19/381,549

(22) Filed: Nov. 6, 2025

(30) Foreign Application Priority Data
Nov. 13, 2024 (JP) 2024-198410

(51) Int. Cl. G03G 9/087

(52) U.S. Cl. CPC G03G 9/08797; G03G 9/08755

(57) ABSTRACT

A toner having a toner particle that contains an amorphous polyester resin and a crystalline polyester resin is provided, wherein the amorphous polyester resin contains a modified amorphous polyester resin having a linear alkyl compound and being condensed to a terminal, and the crystalline polyester resin contains a modified crystalline polyester resin having a linear alkyl compound and being condensed to a terminal, the number average D_{A} (nm) of the long axis lengths of the crystals of the crystalline polyester resin observed on the cross-section of a sample A obtained by melting the toner at 150° C. and then cooling the toner to 25° C. and the number average D_{B} (nm) of the long axis lengths of the crystals of the crystalline polyester resin observed on the cross-section of a sample B obtained by allowing the sample A to stand at 50° C. for 72 hours meet specific relationships.

### BACKGROUND

### Field of the Technology

The present disclosure relates to a toner used in electrophotographic systems, electrostatic recording systems, and electrostatic printing systems.

### Description of the Related Art

In recent years, electrophotographic devices such as full-color printers and full-color copying machines have been increasingly required to provide additional value such as high productivity, high image quality, and high stability. To achieve high productivity, it is essential to melt the toner more quickly during the fixing step. Specifically, a toner that can be fixed at a lower temperature and shows excellent low-temperature fixability is required.

Japanese Patent Application laid-open No. 2004-046095 discloses as a toner excellent in low-temperature fixability a toner containing a crystalline polyester for a binder resin in the toner. The crystalline polyester has a higher sharp melt property than an amorphous polyester and functions as a plasticizer of the amorphous polyester. Thus, the crystalline polyester is a material effective for fixing the toner at a low temperature.

However, when the compatibility between the crystalline polyester and the amorphous polyester is increased in order to improve the low-temperature fixability, there may be a case where the crystalline polyester is not crystallized in a toner, and the charge retention property is deteriorated. Thus, Japanese Patent Application laid-open No. 2016-110150 discloses a production method of accelerating crystallization of a crystalline polyester by annealing a toner in order to attain both low-temperature fixability and charge retention property.

In a toner containing a crystalline resin having a low-temperature fixability, the binder resin and the plasticizer often continue to be compatible with each other in the toner melt forming a fixed image. As a result, the heat resistance of the toner decreases, and the toner melt is liable to adhere to the rear surface of the paper having thereon an output image or another fixed image, hence an image defect may occur. One of these image defects is sheet adhesion.

In particular, in the case of double-sided printing, fixed image parts are inevitably placed in a state of contact with each other, hence image defects are more liable to occur than in the case of single-sided printing. Therefore, a toner capable of achieving both a low-temperature fixability and a resistance to sheet adhesion has been demanded.

Meanwhile, if a fixed image printed by using a toner containing a crystalline resin is stored for a long period of time, the crystalline resin may be gradually annealed, crystallization may progress, and an acicular crystalline domain having a large aspect ratio may be formed in the fixed image. When the crystalline resin is crystallized, the crystalline resin becomes brittle, and when the fixed image is bent, cracks easily occur in the image, and an image defect may occur.

According to studies by the present inventors, the toner of Japanese Patent Application laid-open No. 2016-110150 satisfies both the low-temperature fixability and the charge retention property by annealing in the state of a toner, but after fixing, the crystallization is delayed. As a result, the resistance to sheet adhesion decreases, and crystallization progresses during long-term storage, resulting in a decrease in resistance to folding.

### SUMMARY

The present disclosure provides a toner that exhibits excellent low-temperature fixability and charge retention properties, suppresses sheet adhesion immediately after fixing, and does not easily lose the resistance to folding, even during long-term storage.

The present disclosure is related to a toner comprising a toner particle that comprises an amorphous polyester resin and a crystalline polyester resin, the amorphous polyester resin comprising a modified amorphous polyester resin having at least one linear alkyl compound condensed to a terminal, selected from the group consisting of linear C16-24 aliphatic monocarboxylic acids and linear C16-24 aliphatic monoalcohols; the crystalline polyester resin comprising a modified crystalline polyester resin having at least one linear alkyl compound condensed to a terminal, selected from the group consisting of linear C16-24 aliphatic monocarboxylic acids and linear C16-24 aliphatic monoalcohols; and when a cross-section of a sample A obtained by melting the toner at 150° C. and then cooling the toner to 25° C. at a rate of 100° C./min is observed using a transmission electron microscope, and a number average of the long axis lengths of crystals of the crystalline polyester resin observed on the cross section is taken as D_{A} (nm), and when a cross-section of a sample B obtained by allowing the sample A to stand at 50° C. for 72 hours is observed using a transmission electron microscope, and a number average of the long axis lengths of crystals of the crystalline polyester resin observed in the cross-section is taken as D_{B} (nm), the D_{A} and the D_{B} satisfying expressions (1) and (2) below:

$$10 nm \leq {D}_{A} \leq 100 nm \qquad ( 1 )$$

$$1 nm \leq {D}_{B} - {D}_{A} \leq 20 nm . \qquad ( 2 )$$

Features of the present disclosure will become apparent from the following description of embodiments. The following description of embodiments is described by way of example.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple XXs may be selected from the group, and the same applies to YY and ZZ.

The term “monomer unit” refers to a reacted form of a monomer substance in a polymer.

A crystalline polyester resin refers to a resin having a main skeleton that exhibits crystallinity and shows an endothermic peak observed in differential scanning calorimetric (DSC) measurement.

The present disclosure is related to a toner comprising a toner particle that comprises an amorphous polyester resin and a crystalline polyester resin, the amorphous polyester resin comprising a modified amorphous polyester resin having at least one linear alkyl compound condensed to a terminal, selected from the group consisting of linear C16-24 aliphatic monocarboxylic acids and linear C16-24 aliphatic monoalcohols; the crystalline polyester resin comprising a modified crystalline polyester resin having at least one linear alkyl compound condensed to a terminal, selected from the group consisting of linear C16-24 aliphatic monocarboxylic acids and linear C16-24 aliphatic monoalcohols; and when a cross-section of a sample A obtained by melting the toner at 150° C. and then cooling the toner to 25° C. at a rate of 100° C./min is observed using a transmission electron microscope, and a number average of the long axis lengths of crystals of the crystalline polyester resin observed on the cross section is taken as D_{A} (nm), and when a cross-section of a sample B obtained by allowing the sample A to stand at 50° C. for 72 hours is observed using a transmission electron microscope, and a number average of the long axis lengths of crystals of the crystalline polyester resin observed in the cross-section is taken as D_{B} (nm), the D_{A} and the D_{B} satisfying expressions (1) and (2) below:

$$10 nm \leq {D}_{A} \leq 100 nm \qquad ( 1 )$$

$$1 nm \leq {D}_{B} - {D}_{A} \leq 20 nm . \qquad ( 2 )$$

The present inventors have intensively studied a toner that exhibits excellent low-temperature fixability and charge retention properties, suppresses sheet adhesion immediately after fixing, and does not easily lose the resistance to folding, even during long-term storage. As a result, the present inventors have found that the toner described above can solve the problem. First, it is important to maintain a microcrystalline state with almost no change in the crystal domains when the toner is melted and then rapidly cooled and the crystal domains after annealing. It is also important that both the amorphous polyester resin and the crystalline polyester resin contained in the toner are terminal-modified by a linear long-chain alkyl having a specific chain length.

The present inventors believe that the mechanism by which the effects of the present disclosure are exhibited is as follows.

The step of melting the toner at 150° C. and then rapidly cooling the toner to 25° C. at a rate of 100° C./min to obtain a sample A simulates the cooling rate of the toner after melting during fixing, and the condition of the fixed substance immediately after fixing can be observed by loading a similar change to the toner. Therefore, it is considered that the toner in which the crystalline polyester resin crystallizes, thereby satisfying the expression (1), becomes hard even immediately after fixing, and the resistance to sheet adhesion becomes favorable.

The step of allowing the sample A to stand at 50° C. for 72 hours to obtain a sample B is a test for accelerating the state where the fixed substance that has elapsed for a long period of time and is in a sufficiently transitional state for evaluation. Therefore, satisfying the expression (2) means that the change in size of the crystal domains after allowing a sample for 72 hours at 50° C. is very small; that is, the change in size of the crystal domains in the fixed substance that has elapsed for a long time is very small.

Therefore, satisfying the expressions (1) and (2) means that the crystal domains hardly change even after the lapse of a long period of time and remain in a microcrystalline state. It is considered that when the fixed substance is folded immediately after fixing and after the lapse of a long period of time has passed, the crystal domain is small, and the starting point of the generation of a crack is hard to occur. Therefore, it is possible to improve the resistance to folding.

Thus, it is considered that after rapid cooling, the crystalline polyester resin immediately crystallizes and forms microcrystals with small crystal domains, and the crystal domains hardly become large after the lapse of a long period of time, thereby achieving both the resistance to sheet adhesion and the resistance to folding.

Furthermore, in the toner, the amorphous polyester resin and the crystalline polyester resin respectively contain a modified amorphous polyester resin and a modified crystalline polyester resin in which a linear aliphatic monocarboxylic acid or a linear aliphatic monoalcohol having a specific chain length is condensed to the terminals. That is, the terminals of the amorphous polyester resin and the crystalline polyester resin are modified by a linear alkyl compound having a specific length. It is believed that the terminal alkyl chain of the modified amorphous polyester resin and the terminal alkyl chain of the modified crystalline polyester resin interact with each other to reduce the size of the crystalline domain. Therefore, it is believed that the crystalline polyester resin crystallizes in the microcrystalline state in a range satisfying the expression (2) when the crystalline polyester resin is in a sufficiently transitional state, and the resistance to sheet adhesion and the resistance to folding were further improved.

It is believed that when the carbon number of the terminal alkyl chain of the modified amorphous polyester resin and that of the terminal alkyl chain of the modified crystalline polyester resin are within the above range, the carbon numbers are close to each other, and thus, the interaction is strengthened and the effect like eutectic is exhibited. Hereinafter, a preferable constitution of the toner will be described.

A toner particle contains an amorphous polyester resin and a crystalline polyester resin. The toner particle contains an amorphous polyester resin and a crystalline polyester resin, for example, as the binder resin. The binder resin preferably contains a polyester resin as a main component from the viewpoint of low-temperature fixability. The term “main component” means that the content thereof is 50 mass % or more. The content ratio of the polyester resin in binder resins including an amorphous polyester resin and a crystalline polyester is, for example, 50 to 100 mass %, preferably 80 to 100 mass %, and more preferably 90 to 100 mass %. Also, the toner particle may contain a resin other than the amorphous polyester resin and the crystalline polyester resin to such an extent that the effects of the present disclosure are not impaired.

### Amorphous Polyester Resin

The amorphous polyester resin contains a modified amorphous polyester resin with at least one linear alkyl compound condensed to a terminal, selected from the group consisting of linear C16-24 aliphatic monocarboxylic acids and linear C16-24 aliphatic monoalcohols. That is, the modified amorphous polyester resin includes a polyester chain having a monomer unit corresponding to a linear alkyl compound at the terminal. The modified amorphous polyester preferably has a condensation polymer of a carboxylic acid and alcohol, with an aromatic diol as the main component.

An alcohol with an aromatic diol as the main component means that the aromatic diol content is 50 mass % or more in all alcohols constituting the modified amorphous polyester resin, other than the monoalcohol which is condensed to form a molecular chain described later.

The aromatic diol used in the modified amorphous polyester resin is not particularly limited, but examples thereof may include bisphenol derivatives represented by the following formula (A) and diols represented by the following formula (B). The aromatic diol is preferably a bisphenol derivative represented by formula (A).

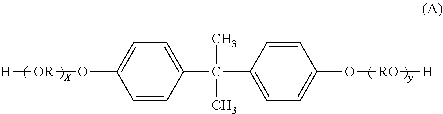

In the formula, R represents an ethylene group or a propylene group, x and y are each an integer of 1 or greater, and the average value of x+y is 2 to 7.

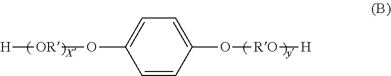

In the formula, R′ represents

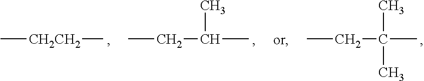

and x′ and y′ are each an integer of 0 or greater, and the average value of x′+y′ is 0 to 10.

Examples of the bisphenol derivatives represented by formula (A) may include the following.

Polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxypropylene (2.0)-polyoxyethylene (2.0)-2,2-bis(4-hydroxyphenyl) propane, polyoxypropylene (6)-2,2-bis(4-hydroxyphenyl) propane, and the like.

Examples of alcohols other than the bisphenol derivatives represented by the formula (A) or the diols represented by the formula (B) may include the following.

Ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentantriol, glycerin, 2-methylpropane triol, 2-methyl-1,2,4-butanetriol, trimethylolethane, trimethylolpropane, 1,3,5-trihydroxymethylbenzene, and the like.

These alcohols may be used alone or two or more thereof may be used in combination.

As mentioned above, the main component of the alcohol is preferably an aromatic diol. In the alcohol, the content of the aromatic diol in all alcohols constituting the modified amorphous polyester resin, other than the monoalcohol which is condensed to the terminal of the modified amorphous polyester resin to form a linear alkyl at the molecular chain terminal is preferably 80 to 100 mass %, and more preferably 90 to 100 mass %.

Examples of carboxylic acids used in the modified amorphous polyester resin may include the following polyvalent carboxylic acids. Examples of dicarboxylic acids may include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, and the like. Among them, dicarboxylic acid is preferably at least one selected from the group consisting of maleic acid, fumaric acid, and terephthalic acid.

Examples of tricarboxylic acids or further polycarboxylic acids may include the following: 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexane tricarboxylic acid, 1,3-dicarboxyl-2-methyl-2-methylenecarboxypropane, 1,2,4-cyclohexane tricarboxylic acid, tetra(methylenecarboxy) methane, 1,2,7,8-octanetetracarboxylic acid, pyromellitic acid, Empol trimer acid, and anhydrides thereof and lower alkyl esters thereof, and the like.

Among these, 1,2,4-benzenetricarboxylic acid (that is, trimellitic acid) or a derivative thereof is preferable because it is not expensive, and the reaction can be easily controlled.

These dicarboxylic acids, tricarboxylic acids, and further polycarboxylic acids may be used alone or two or more thereof may be used in combination.

The main component of carboxylic acids constituting the modified amorphous polyester resin is preferably a dicarboxylic acid. The term “main component” as used herein means the case where the content of dicarboxylic acid in the total carboxylic acids constituting the modified amorphous polyester resin is 50 mass % or more. In the carboxylic acids, the dicarboxylic acid content in all carboxylic acids constituting the modified amorphous polyester resin, other than the monocarboxylic acid that is condensed to the terminal of the modified amorphous polyester resin to form a linear alkyl group at the molecular chain terminal, is preferably 80 to 100 mass %, and more preferably 90 to 100 mass %.

The amorphous polyester resin preferably contains a modified amorphous polyester resin with at least one linear alkyl compound condensed to a terminal, selected from the group consisting of a linear C16-24 alkyl monocarboxylic acid and a linear C16-24 alkyl monoalcohol is condensed to a terminal.

The modified amorphous polyester resin may have a molecular chain terminal to which linear alkyl compounds having a plurality of chain lengths are condensed, and may also have a molecular chain terminal to which a linear alkyl compound having a chain length other than the above range, to the extent that the effects of the present disclosure are not impaired. It is preferable that 90 mass % or more of the terminal-modified linear alkyl compound have carbon atoms within the range of 16 to 24, and it is more preferable that 100 mass % thereof have carbon atoms within the range of 16 to 24.

When a carboxy group is present at a molecular chain terminal of the amorphous polyester resin before the condensation of the linear alkyl compound, condensation reaction with a linear aliphatic monoalcohol occurs.

Meanwhile, when a hydroxy group is present at a molecular chain terminal of the amorphous polyester resin before the condensation of the linear alkyl compound, a condensation reaction with a linear aliphatic monocarboxylic acid occurs.

Accordingly, the terminal of the molecular chain, when the linear alkyl compound is condensed to the terminal, becomes a group formed by elimination of a hydrogen atom in the hydroxy group of the linear aliphatic monoalcohol, or a group formed by elimination of —OH in the carboxy group of the linear aliphatic monocarboxylic acid. In this case, a linear chain alkyl group means an alkyl group included in a group formed by elimination of a hydrogen atom in a hydroxy group of a linear aliphatic monoalcohol, or a group formed by elimination of —OH in a hydroxy group of the linear aliphatic monocarboxylic acid.

When the modified amorphous polyester resin has a branched chain, the molecular chain terminals include the terminal of the branched chain.

Examples of linear C16 to C24 aliphatic monocarboxylic acid may include the following: palmitic acid (hexadecanoic acid), margaric acid (heptadecanoic acid), stearic acid (octadecanoic acid), nonadecylic acid, arachidic acid (icosanoic acid), heneicosylic acid, behenic acid (docosanoic acid), tricosanoic acid, and tetracosanoic acid.

Meanwhile, examples of linear C16 to C24 aliphatic monoalcohols may include the following: palmityl alcohol (hexadecanol), heptadecanol, stearyl alcohol (octadecanol), nonadecanol, arachidyl alcohol (icosanol), heneicosanol, behenyl alcohol, lignoseryl alcohol, tricosanol, and tetracosanol.

When the number of carbon atoms is less than 16, the interaction between the linear chain alkyls would be insufficient, the modified crystalline polyester resin cannot be constrained by the modified amorphous polyester resin, and the crystalline domain of the crystalline polyester resin becomes large, so that the low-temperature fixability decreases as a toner, and the resistance to folding of a fixed substance after long-term storage decreases. If the number of carbon atoms is too short, it is difficult to crystallize, and the effect as a nucleus cannot be obtained, so that the crystallization is delayed, and the charge retention property of the toner and the resistance to sheet adhesion of the fixed substance decrease.

In contrast, if the number of carbon atoms is larger than 24, the mobility of the linear chain alkyl segment becomes too high, so that the modified amorphous polyester resin cannot restrain the linear chain alkyl segment of the modified crystalline polyester resin, and the crystal domain becomes large. As a result, the low-temperature fixability of the toner decreases, and the resistance to folding of the fixed substance after long-term storage decreases.

The carbon number of the linear alkyl compound condensed to a terminal of the modified amorphous polyester resin is preferably 18 to 22, and more preferably 18 to 20.

The terminal-modified amorphous polyester resin may have a crystallinity derived from the terminal linear chain alkyl. A modified amorphous polyester resin alone that has a degree of crystallinity of 10% or less when allowed to stand at 30° C. and 80% RH for 1 week is regarded as an amorphous polyester resin.

The degree of crystallinity was measured using an X-ray diffractometer, MiniFlex 600 (manufactured by Rigaku Corp.). A powdered sample was placed on a non-reflective sample plate and measured under the following measuring conditions.
X-ray source: CuKα ray
Output: 40 kV, 15 mA
Slit system: DS=0.625°, SS=8 mm, RS=13 mm
Detector: D/teX Ultra
Scanning method: 2θ/θ continuous scan
Measurement range (2θ): 5° to 60° Step width (2θ) 0.02°

The degree of crystallinity was defined as the percentage when the sum of the integrated intensities derived from crystals is divided by the sum of the integrated intensities of all peaks after drawing the background from the measurement results and performing peak separation.

The modified amorphous polyester resin may be produced according to an ordinary polyester synthesis method. For example, the above carboxylic acid monomer and alcohol monomer are esterified or transesterified. Thereafter, a condensation polymerization reaction is carried out under reduced pressure or by introducing nitrogen gas according to an ordinary method, whereby a desired polyester resin can be obtained.

However, during the reaction between the carboxylic acid monomer and the alcohol monomer, if the linear aliphatic monocarboxylic acid or the linear aliphatic monoalcohol, which forms the terminals of the molecular chain, are present at the same time, the linear alkyl compound forms the molecular chain terminals. Therefore, the terminals function as terminal caps, and there is a possibility that the molecular chain is extremely shortened. Therefore, the linear alkyl compound may be added to the reaction system after the reaction between the carboxylic acid monomer and the alcohol monomer has proceeded.

The esterification or transesterification reaction may be optionally conducted using conventional esterification or transesterification catalysts, such as sulfuric acid, titanium butoxide, dibutyltin oxide, tin 2-ethylhexanoate, manganese acetate, and magnesium acetate.

The condensation polymerization reaction may be conducted using an ordinary polymerization catalyst, such as titanium butoxide, dibutyltin oxide, tin 2-ethylhexanoate, tin acetate, zinc acetate, tin disulfide, antimony trioxide, and germanium dioxide. The polymerization temperature and the amount of the catalyst are not particularly limited, and may be determined as appropriate.

The proportion (modification rate) of terminals to which a linear alkyl compound is condensed among molecular chain terminals of the modified amorphous polyester resin is, for example, 0.5 mol % or more and less than 25 mol %, preferably 1 mol % or more and less than 25 mol %, more preferably 2 to 15 mol %, and still more preferably 2 to 10 mol %. When the modification rate of the molecular chain terminals of the modified amorphous polyester resin is 1 mol % or more, the modified amorphous polyester resin can interact more fully with the terminal alkyls of the modified crystalline polyester resin. In contrast, when the modification rate of the molecular chain terminals of the modified amorphous polyester resin is less than 25 mol %, the distance between the modified crystalline polyesters that have interacted with the modified amorphous polyester is appropriately maintained, and the crystalline domain is easily reduced.

The modification rate indicates a proportion of terminals to which a linear alkyl compound is condensed in the terminals (carboxy groups and hydroxy groups) of a polyester resin. Having the modification rate described above means that the polyester molecular chain included in the modified amorphous polyester resin contains a polyester molecular chain in which a linear alkyl compound is condensed to a molecular chain terminal at the modification rate described above. That is, the modified amorphous polyester resin may be a mixture of a polyester molecular chain in which a linear alkyl compound has been condensed to a molecular chain terminal and a polyester molecular chain in which a linear alkyl compound has not been condensed to a molecular chain terminal.

The glass transition temperature (Tg) of the modified amorphous polyester resin measured using a differential scanning calorimeter (DSC) is preferably from 40.0° C. to 60.0° C. and is more preferably from 45.0° C. to 52.0° C. When the Tg is within the above range, both the low-temperature fixability and the blocking resistance are easily achieved.

The number average molecular weight Mn of the modified amorphous polyester resin may preferably be 1500 to 10000, or 2000 to 4000. The weight-average molecular weight Mw of the modified amorphous polyester resin is preferably 2000 to 20000, 3000 to 10000, or 3000 to 8000.

The amorphous polyester resin may further contain an amorphous polyester resin B, which is different from the modified amorphous polyester resin. The amorphous polyester resin B may be a condensation polymer of an alcohol and a carboxylic acid other than a monoalcohol and a monocarboxylic acid in the modified amorphous polyester resin described above.

Alcohol preferably contains an aromatic diol. The aromatic diol content in all alcohols constituting the amorphous polyester resin B is preferably 80 to 100 mass %, and more preferably 90 to 100 mass %.

The carboxylic acid is preferably at least one selected from the group consisting of maleic acid, fumaric acid, and terephthalic acid. The amorphous polyester resin B is preferably crosslinked with a trivalent carboxylic acid, such as trimellitic acid or trimellitic anhydride.

The glass transition temperature (Tg) of the amorphous polyester resin B measured using a differential scanning calorimeter (DSC) is preferably from 50.0° C. to 70.0° C. and is more preferably from 50.0° C. to 65.0° C.

The number average molecular weight Mn of the amorphous polyester resin B may preferably be 2000 to 10000, or 2500 to 6000. The weight-average molecular weight Mw of the amorphous polyester resin B may preferably be 2000 to 20000, or 5000 to 15000.

The content ratio of the modified amorphous polyester resin in the amorphous polyester resin may be, for example, 50 to 95 mass %, or 60 to 80 mass %.

The content ratio of the amorphous polyester resin B in the amorphous polyester resins may be, for example, 5 to 50 mass % or 20 to 40 mass %.

The content ratio of the modified amorphous polyester resin on the basis of the mass of the toner particle may be, for example, 20.0 to 80.0 mass %, 30.0 to 70.0 mass %, or 40.0 to 60.0 mass %.

The content ratio of the amorphous polyester resin B based on the mass of the toner particle may be, for example, 5.0 to 40.0 mass %, 10.0 to 30.0 mass %, or 15.0 to 25.0 mass %.

### Crystalline Polyester

The toner particle contains a crystalline polyester resin. The crystalline polyester resin contains a modified crystalline polyester resin with at least one linear alkyl compound condensed to a terminal, selected from the group consisting of linear C16-24 aliphatic monocarboxylic acids and linear C16-24 aliphatic monoalcohols. That is, the modified crystalline polyester resin contains a polyester chain having a monomer unit corresponding to the linear alkyl compound at the terminal. The crystalline polyester resin, for example, has a main skeleton with crystallinity and preferably a weight-average molecular weight of 5000 or more.

Examples of monomers used in the modified crystalline polyester resin may include polyhydric alcohols (di-, tri- or further poly-hydric alcohols), polycarboxylic acids (di-, tri- or further poly-carboxylic acids), anhydrides thereof and lower alkyl esters thereof. The structure other than the terminal to which the linear alkyl compound is condensed in the modified crystalline polyester resin is preferably a condensation polymer of an aliphatic dicarboxylic acid and an aliphatic diol.

As the polyhydric alcohol monomers to be used in the modified crystalline polyester resin, the following polyhydric alcohol monomers may be used. The polyhydric alcohol monomer is not particularly limited, but is preferably a chain-like (more preferably linear) aliphatic diol. Examples of polyhydric alcohol monomers may include ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol.

Among these, linear aliphatic α,ω-diols, such as ethylene glycol, diethylene glycol, 1,4-butanediol, and 1,6-hexanediol, are particularly preferably exemplified.

Polyhydric alcohol monomers other than the above polyhydric alcohol may also be used. Among the above polyhydric alcohol monomers, examples of dihydric alcohol monomers may include aromatic alcohol, such as polyoxyethylenated bisphenol A or polyoxypropylenated bisphenol A; 1,4-cyclohexanedimethanol; and the like. Among the polyhydric alcohol monomers, examples of trihydric or further polyhydric alcohol monomers may include aromatic alcohols, such as 1,3,5-trihydroxymethylbenzene; and aliphatic alcohols, such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, and trimethylolpropane.

As the polycarboxylic acid monomers to be used in the modified crystalline polyester resin, the following polycarboxylic acid monomers may be used. The polyvalent carboxylic acid monomer is not particularly limited, but is preferably a chain-like (more preferably linear) aliphatic dicarboxylic acid

Specific examples thereof may include oxalic acid, malonic acid, succinic acid, glutaric acid, adipic acid, pimelic acid, suberic acid, glutamic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid, and also include anhydrides or lower alkyl esters of these polycarboxylic acids.

It is also possible to use polycarboxylic acids other than the above polycarboxylic acid monomers. Among other polycarboxylic acid monomers, examples of dicarboxylic acids may include aromatic carboxylic acids, such as isophthalic acid and terephthalic acid; aliphatic carboxylic acids, such as n-dodecylsuccinic acid and n-dodecenylsuccinic acid; alicyclic carboxylic acids, such as cyclohexane dicarboxylic acid, and also include anhydrides or lower alkyl esters of these acids.

Among other carboxylic acid monomers, examples of tricarboxylic or further polycarboxylic acids may include atomatic carboxylic acids, such as 1,2,4-benzenetricarboxylic acid (trimellitic acid), 2,5,7-naphthalenetricarboxylic acid, 1,2,4-naphthalenetricarboxylic acid, and pyromellitic acid; and aliphatic carboxylic acids, such as 1,2,4-butanetricarboxylic acid, 1,2,5-hexanetricarboxylic acid, and 1,3-dicarboxy-2-methyl-2-methylenecarboxypropane, and also include anhydrides or lower alkyl esters of these polycarboxylic acids.

The aliphatic dicarboxylic acid is preferably a linear C2-16 (preferably C8-14) aliphatic dicarboxylic acid. The aliphatic diol is preferably a linear C2-16 (preferably C2-6) aliphatic diol. The content ratio of monomer units formed by polymerization of a linear C2-16 (preferably C8-14) aliphatic dicarboxylic acid in the modified crystalline polyester resin is preferably 8 to 45 mass %, and more preferably 20 to 35 mass %. The content ratio of monomer units formed by polymerization of a linear C2-16 (preferably C2-6) aliphatic diol in the modified crystalline polyester resin is preferably 15 to 50 mass %, and more preferably 25 to 45 mass %.

The crystalline polyester resin contains a modified crystalline polyester resin with at least one linear alkyl compound condensed to a terminal, selected from the group consisting of linear C16-24 aliphatic monocarboxylic acids and linear C16-24 aliphatic monoalcohols. The crystalline polyester resin preferably includes a modified crystalline polyester resin having a molecular chain terminal to which at least one linear alkyl compound selected from the group consisting of a linear C16 to C24 alkyl monocarboxylic acid and a linear C16 to C24 alkyl monoalcohol is condensed.

The modified crystalline polyester resin may have molecular chain terminals to which linear alkyl compounds having a plurality of chain lengths are condensed, and may also have a molecular chain terminal to which a linear alkyl compound having a chain length other than the above range, as long as the effects of the present disclosure are not impaired. It is preferable that 90 mass % or more of the terminal-modified linear alkyl compound have carbon atoms within the range of 16 to 24, and it is more preferable that 100 mass % thereof have carbon atoms within the range of 16 to 24.

Examples of linear C16 to C24 aliphatic monocarboxylic acid may include the following: palmitic acid (hexadecanoic acid), margaric acid (heptadecanoic acid), stearic acid (octadecanoic acid), nonadecylic acid, arachidic acid (icosanoic acid), heneicosylic acid, behenic acid (docosanoic acid), tricosanoic acid, and tetracosanoic acid.

Meanwhile, examples of linear C16 to C24 aliphatic monoalcohols may include the following: palmityl alcohol ol (hexadecanol), heptadecanol, stearyl alcohol (octadecanol), nonadecanol, arachidyl alcohol (icosanol), heneicosanol, behenyl alcohol, lignoseryl alcohol, tricosanol, and tetracosanol.

When the number of carbon atoms is less than 16, the interaction between linear alkyl groups is insufficient, so that the modified crystalline polyester resin is not constrained by the terminal alkyl of the modified amorphous polyester resin, and the crystal domain of the crystalline polyester resin becomes large. As a result, the low-temperature fixability of the toner decreases, and the resistance to folding of the fixed substance after long-term storage decreases. If the number of carbon atoms is too short, is difficult to crystallize, and the effect as a nucleus cannot be obtained, so that the crystallization is delayed, and the charge retention properties of the toner and the resistance to sheet adhesion of the fixed substance decrease.

Meanwhile, if the number of carbon atoms is larger than 24, the mobility of the linear chain alkyl segment becomes too high, so that the linear chain alkyl segment of the modified amorphous polyester resin cannot constrain the modified crystalline polyester resin, and the crystal domain becomes large. As a result, the low-temperature fixability of the toner decreases, and the resistance to folding of the fixed substance after long-term storage decreases.

The modified crystalline polyester resin may be produced according to a normal polyester synthesis method. For example, a crystalline polyester resin can be obtained by subjecting the above-mentioned dicarboxylic acid and diol to an esterification reaction or a transesterification reaction, and then carrying out a polycondensation reaction under reduced pressure or by introducing nitrogen gas according to an ordinary method. Thereafter, the above-mentioned linear alkyl compound is further added, and an esterification reaction is carried out to obtain a desired modified crystalline polyester resin.

The esterification or transesterification reaction may be optionally conducted using ordinary esterification or transesterification catalysts, such as sulfuric acid, titanium butoxide, dibutyltin oxide, manganese acetate, and magnesium acetate.

The polycondensation reaction may be conducted using an ordinary polymerization catalyst, such as titanium butoxide, dibutyltin oxide, tin acetate, zinc acetate, tin disulfide, antimony trioxide, and germanium dioxide. The polymerization temperature and catalyst amount are not particularly limited and may be determined as appropriate.

In an esterification or transesterification reaction, or a polycondensation reaction, all monomers may be charged in batches to increase the strength of the modified crystalline polyester resin obtained, or a divalent monomer may be first reacted to reduce the low-molecular-weight components, and then a trivalent or higher valent monomer may be added, followed by the reaction.

In synthesizing the crystalline polyester resin containing a modified crystalline polyester resin, it is preferable to polycondensate at least one (preferably, the above-mentioned linear aliphatic monocarboxylic acid) selected from the group consisting of the above-mentioned linear aliphatic monocarboxylic acids and linear aliphatic monoalcohols, as well as an aliphatic diol and an aliphatic dicarboxylic acid.

In the modified crystalline polyester resin, the proportion of monomer units formed by the polymerization of aliphatic diols is preferably 30 to 50 mol %, and more preferably 35 to 45 mol %. In the modified crystalline polyester resin, the proportion of monomer units formed by the polymerization of aliphatic dicarboxylic acids is preferably 5 to 45 mol %, and more preferably 10 to 35 mol %. The proportion of at least one (preferably, the above-mentioned linear aliphatic monocarboxylic acid) selected from the group consisting of the linear aliphatic monocarboxylic acids and linear aliphatic monoalcohols mentioned above is preferably 15 to 60 mol %, and more preferably 20 to 30 mol %.

The content ratio of the monomer unit from a linear alkyl compound at the molecular chain terminal of the modified crystalline polyester resin is preferably 1.0 to 30.0 mass %, more preferably 2.0 to 25.0 mass %, and still more preferably 4.0 to 12.0 mass %.

In the modified crystalline polyester resin, the proportion of monomer units formed by the polymerization of aliphatic diols is preferably 10 to 40 mass %, and more preferably 15 to 25 mass %. In the modified crystalline polyester resin, the proportion of monomer units formed by the polymerization of aliphatic dicarboxylic acids is preferably 40 to 85 mass %, more preferably 60 to 80 mass %.

The content ratio of the modified crystalline polyester resin in the crystalline polyester resin may be, for example, 50 to 100 mass %, 80 to 100 mass %, or 90 to 100 mass %. The crystalline polyester resin may be a modified crystalline polyester resin.

The content ratio W_{C} of the crystalline polyester resin (for example, modified crystalline polyester resin) based on the mass of the toner particle is preferably 3.0 to 25.0 mass %, more preferably 5.0 to 20.0 mass %, and still more preferably 5.0 to 18.0 mass %. It is preferable from the viewpoint of highly achieving all of the low temperature fixability, the charge retention property, the resistance to sheet adhesion, and the resistance to folding. The melting point of the modified crystalline polyester is preferably 60° C. to 105° C., more preferably 65° C. to 100° C., and still more preferably 70° C. to 95° C.

The weight-average molecular weight Mw of the modified crystalline polyester resin is preferably 10000 to 30000 and more preferably 15000 to 25000. When the Mw is 10000 or more, compatibility with the modified amorphous polyester resin decreases, and crystallization is accelerated, so that the charge retention property and the resistance to sheet adhesion are more easily improved. When the Mw is 30000 or less, the terminal alkyl of the modified amorphous polyester resin easily constrains the modified crystalline polyester resin, the crystal domain becomes small, and the low-temperature fixability and the resistance to folding are easily improved.

The number average molecular weight of the modified crystalline polyester resin may preferably be 1000 to 10000, or 2000 to 7000.

The proportion (modification rate) of terminals to which a linear alkyl compound is condensed among molecular chain terminals of the modified crystalline polyester resin is, for example, 15 to 75 mol %, preferably 20 to 70 mol %, more preferably 35 to 65 mol %, and still more preferably 45 to 60 mol %. When the proportion is within the above range, the interaction between the terminal alkyl of the modified crystalline polyester resin and the modified amorphous polyester resin is strengthened, the modified crystalline polyester resin is more easily constrained, the crystal domain is smaller, and the low-temperature fixability and the resistance to folding are more easily improved.

The modification rate indicates a proportion of terminals to which a linear alkyl compound is condensed in the terminals (carboxy groups and hydroxy groups) of a polyester resin. Having the modification rate described above means that the polyester molecular chain included in the modified crystalline polyester resin contains a polyester molecular chain in which a linear alkyl compound is condensed to a molecular chain terminal at the modification rate described above. That is, the modified crystalline polyester resin may be a mixture of a polyester molecular chain in which a linear alkyl compound has been condensed to the molecular chain terminal and a polyester molecular chain in which a linear alkyl compound has not been condensed to a molecular chain terminal.

The toner is melted at 150° C., and then cooled to 25° C. at a rate of 100° C./min to obtain a sample A. A cross-section of the sample A is observed using a transmission electron microscope (TEM), and the number average of the long axis lengths of crystals of the crystalline polyester resin observed on the cross-section is defined as D_{A} (nm).

Then, the sample A is allowed to stand at 50° C. for 72 hours to obtain a sample B. A cross-section of the sample B is observed using a transmission electron microscope (TEM), and the number average of the long axis lengths of crystals of the crystalline polyester resin observed on the cross-section is defined as D_{B} (nm).

In this case, it is necessary that the D_{A} and the D_{B} satisfy the following expressions (1) and (2).

$$10 nm \leq {D}_{A} \leq 100 nm \qquad ( 1 )$$

$$1 nm \leq {D}_{B} - {D}_{A} \leq 20 nm \qquad ( 2 )$$

As described above, the step of melting the toner and then cooling the toner to 25° C. at a rate of 100° C./min to obtain the sample A simulates the temperature change of the fixed substance upon fixing. At this time, if the crystalline polyester resin is crystallized to satisfy the expression (1), the resistance to sheet adhesion is improved. In addition, it is necessary to satisfy the expression (2) after subsequent leaving for 50° C. for 72 hours. Satisfying the expression (2) means that crystal growth can be suppressed from 1 to 20 nm, and resistance to folding is improved.

It is preferable that D_{A} is from 10 to 50 nm. It is preferable that D_{B} satisfies the expression (2) and, for example, is from 15 to 100 nm and from 20 to 70 nm. That is, it is preferable that D_{A} and D_{B} satisfy the following expressions (3) and (4):

$$10 nm \leq {D}_{A} \leq 50 nm \qquad ( 3 )$$

$$20 nm \leq {D}_{B} \leq 70 nm \qquad ( 4 )$$

For example, (D_{B}-D_{A}) may be 1 to 12 nm, or 3 to 12 nm.

As a means for making D_{A} within the range mentioned above, a method of using a modified crystalline polyester resin and a modified amorphous polyester resin in which a linear alkyl compound has been condensed to a terminal may be mentioned. To reduce D_{A}, either or both of the modification rates of the modified crystalline polyester resin and the modified amorphous polyester resin should be increased. To increase D_{A}, either or both of the modification rates of the modified crystalline polyester resin and the modified amorphous polyester resin should be reduced.

As a means for making (D_{B}-D_{A}) within the above range, a method of using a modified crystalline polyester resin and a modified amorphous polyester resin in which a linear alkyl compound has been condensed to a terminal, and a method of making the weight-average molecular weight Mw of the modified amorphous polyester resin small (for example, less than 10000) may be mentioned. In order to reduce (D_{B}-D_{A}), it is supposed to make the alkyl chain lengths of the linear alkyl compounds condensed to the terminals of modified crystalline polyester resins and modified amorphous polyester resins close. To increase (D_{B}-D_{A}), it is supposed to make the difference between the lengths of the alkyl chains greater.

To reduce D_{B}, the modification rate of the modified amorphous polyester resin should be increased. To increase D_{B}, the modification rate of the modified amorphous polyester resin should be reduced.

From the viewpoint of low-temperature fixability, when cross-section of the sample B is observed, the average aspect ratio of crystals of the crystalline polyester resin observed on the cross-section is, for example, 2.0 to 8.0, and preferably 2.5 to 5.0.

To reduce the average aspect ratio, the modification rate of the modified amorphous polyester resin should be increased. To increase the average aspect ratio, the modification rate of the modified amorphous polyester resin should be decreased.

In addition, the SP value of the modified amorphous polyester resin is taken as SP_{A} (cal/cm³)^{0.5}, and the SP value of the modified crystalline polyester resin is taken as SP_{C} (cal/cm³)^{0.5}. In this case, (SP_{A}-SP_{C}) is, for example, 0.7 to 1.3. It is preferable that SP_{A} and SP_{C} satisfy the following expression (5) from the compatibility and ease of crystallization. SP_{A}-SP_{C} is more preferably 0.9 to 1.1.

$$0.8 \leq {SP}_{A} - {SP}_{C} \leq 1.2 \qquad ( 5 )$$

The content ratio of the crystalline polyester resin based on the mass of the toner particle is taken as W_{C} (mass %). In the observation of a cross-section of the sample A by a transmission electron microscope (TEM), an average area ratio of the crystals of the crystalline polyester resin in the area of an observation range is taken as S_{A} (area %). At this time, S_{A}/W_{C} is, for example, 0.05 to 0.5. It is preferable that W_{C} and S_{A} satisfy the following expression (6).

$$0.1 \leq {S}_{A} / {W}_{C} \leq 0.4 \qquad ( 6 )$$

The content ratio of the crystalline polyester resin based on the mass of the toner particle is taken as W_{C} (mass %). In the observation of a cross-section of the sample B by a transmission electron microscope (TEM), an average area ratio of the crystals of the crystalline polyester resin in the area of an observation range is taken as S_{B} (area %). At this time, S_{B}/W_{C} is, for example, 0.2 to 1.0. It is preferable that W_{C} and S_{B} satisfy the following expression (7).

$$0.3 \leq {S}_{B} / {W}_{C} \leq 0.8 \qquad ( 7 )$$

When the value of S_{A}/W_{C} is 0.1 or more, the resistance to sheet adhesion is further improved. Furthermore, when the S_{B}/W_{C} is 0.8 or less, the resistance to folding is further improved.

To reduce S_{A}, the modification rate of the modified crystalline polyester resin should be reduced. To increase S_{A}, the modification rate of the modified crystalline polyester resin should be increased.

To reduce the S_{B}, the modification rate of the modified amorphous polyester resin should be increased, or the modification rate of the modified crystalline polyester resin should be reduced. To increase S_{B}, the modification rate of the modified amorphous polyester resin should be reduced, or the modification rate of the modified crystalline polyester resin should be increased.

It is preferable that the carbon number of the linear alkyl compound condensed to a terminal of the modified crystalline polyester resin is larger than that of the linear alkyl compound condensed to a terminal of the modified amorphous polyester resin. When the number of carbon atoms in the linear alkyl compound modifying the terminal of the amorphous polyester is small, the amorphous polyester resin can rapidly interact with the crystalline polyester resin when the amorphous polyester resin and the crystalline polyester resin are compatible with each other. As a result, crystallization is further accelerated, and both the charge retention property and the resistance to sheet adhesion are further improved.

The difference between the number of carbon atoms in the linear alkyl compound condensed to a terminal of the modified amorphous polyester resin and the number of carbon atoms in the linear alkyl compound condensed to a terminal of the modified crystalline polyester resin is preferably 1 to 6, or 2 to 4.

Examples of preferable combinations of the modified amorphous polyester resin and the modified crystalline polyester resin may include the following. It is particularly preferable that the linear alkyl compound condensed to a terminal of the modified amorphous polyester resin is stearic acid, and the linear alkyl compound condensed to a terminal of the modified crystalline polyester resin is behenic acid. This combination enables higher-order interactions between the crystalline polyester resin and the amorphous polyester resin, resulting in the rapid crystallization of the crystalline polyester resin in a more finely dispersed state.

In addition, it is preferable that the modified crystalline polyester resins have a monomer unit corresponding to ethylene glycol and a monomer unit corresponding to dodecanedioic acid. More preferably, the structure other than the terminal of the modified crystalline polyester resin is a condensation polymer of ethylene glycol and dodecanedioic acid.

When the modified crystalline polyester resin has a monomer unit corresponding to ethylene glycol, the linear alkyl compound is modified to the terminal of the part having a high ester group concentration. If the ester group concentration is high, the crystalline polyester resin approaches the amorphous polyester resin more easily. Thus, the interaction between the terminal alkyls of the modified crystalline polyester resin and the modified amorphous polyester resin is further enhanced.

Also, when the modified crystalline polyester resin has a monomer unit corresponding to dodecanedioic acid, more rapid crystallization and a suitable melting point can be achieved.

### Release Agent

The toner particle may contain a release agent. Examples of release agents may include the following: hydrocarbon waxes, such as low molecular weight polyethylene, low molecular weight polypropylene, an alkylene copolymer, microcrystalline wax, paraffin wax, and Fischer-Tropsch wax; oxides of hydrocarbon waxes, such as an oxidized polyethylene wax, or block copolymers thereof; waxes containing a fatty acid ester, such as carnauba wax, as the main component; and partially or completely deoxidized fatty acid esters, such as deoxidized carnauba wax.

In addition, examples thereof may include the following: saturated linear fatty acids such as palmitic acid, stearic acid, and montanoic acid; unsaturated fatty acids such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols, such as sorbitol; esters of fatty acids, such as palmitic acid, stearic acid, behenic acid, and montanoic acid, and alcohols, such as stearyl alcohol, aralkyl alcohol, behenyl alcohol, carnaubyl alcohol, ceryl alcohol, and melissyl alcohol; fatty acid amides, such as linoleic acid amide, oleic acid amide, and lauric acid amide; saturated fatty acid bisamides, such as methylene bisstearic acid amide, ethylene biscaprylic acid amide, ethylene bislauric acid amide, and hexamethylene bisstearic acid amide; unsaturated fatty acid amides, such as ethylene bisoleic acid amide, hexamethylene bisoleic acid amide, N,N′-dioleyladipic acid amide, and N,N′-dioleyl sebacic acid amide; aromatic bisamides, such as m-xylene bisstearic acid amide, and N,N′-distearyl isophthalic acid amide; aliphatic metal salts, such as calcium stearate, calcium laurate, zinc stearate, and magnesium stearate (generally known as metal soap); waxes in which vinyl monomers, such as styrene and acrylic acid, are grafted onto aliphatic hydrocarbon waxes; partially esterified products of fatty acids and polyhydric alcohols, such as behenic acid monoglyceride; and methyl ester compounds having a hydroxyl group obtained by hydrogenating vegetable oils and fats.

Among these release agents, hydrocarbon waxes, such as paraffin wax and Fischer-Tropsch wax, are preferable from the viewpoint of low-temperature fixability.

The content of the release agent is preferably from 1 to 10 parts by mass relative to 100 parts of the binder resin. Here, the binder resin refers to, for example, the sum of the above-mentioned crystalline polyester resin and the above-mentioned amorphous polyester resin.

### Dispersing Agent

When the toner particle contains a release agent, the toner particle preferably contains a dispersing agent in order to disperse wax in the resin. As the dispersing agent, a well-known one can be used, but when a hydrocarbon wax is contained as the wax, it is preferable to contain a polymer with a structure formed through a reaction between a vinyl resin component and a hydrocarbon compound in order to disperse the wax in a resin. Among these, a graft polymer obtained by graft-polymerizing a vinyl monomer onto a polyolefin is preferable.

When the polymer is contained, the compatibility between the wax and the resin is enhanced, and defects, such as charging failure and member contamination, due to wax dispersion failure, are less likely to occur. In addition, the content of the dispersing agent is preferably from 1.0 to 15 parts by mass with respect to 100 parts by mass of the binder resin. When the content is within this range, the dispersed state of the wax in the amorphous resin is likely to be uniform.

The polyolefin is not particularly limited as long as it is a polymer or a copolymer of unsaturated hydrocarbons, and various polyolefins may be used. In particular, polyethylenes or polypropylenes are preferably used. A plurality of these may be used.

Examples of monomers having a vinyl group may include the following.

styrene-based units, including styrene and derivatives thereof, such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; amino group-containing α-methylene aliphatic monocarboxylic acid esters, such as dimethylaminoethyl methacrylate and diethylaminoethyl methacrylate; N atom-containing vinyl-based units, including acrylic acid or methacrylic acid derivatives, such as acrylonitrile, methacrylonitrile, and acrylamide; unsaturated dibasic acids, such as maleic acid, citraconic acid, itaconic acid, alkenylsuccinic acid, fumaric acid, and mesaconic acid; unsaturated dibasic acid anhydrides, such as maleic anhydride, citraconic anhydride, itaconic anhydride, and alkenyl succinic anhydride; half esters of unsaturated dibasic acids, such as methyl maleate half ester, ethyl maleate half ester, butyl maleate half ester, methyl citraconic acid half ester, ethyl citraconic acid half ester, butyl citraconic acid half ester, methyl itaconic acid half ester, methyl alkenylsuccinic acid half ester, methyl fumaric acid half ester, and methyl mesaconic acid half ester; unsaturated dibasic acid esters, such as dimethylmaleic acid and dimethylfumaric acid; α,β-unsaturated acids, such as acrylic acid, methacrylic acid, crotonic acid, and cinnamic acid; α,β-unsaturated anhydrides, such as crotonic anhydride and caehic anhydride, anhydrides of the above-mentioned α,β-unsaturated acid anhydride with a lower fatty acid; carboxy group-containing vinyl-based units, such as alkenylmalonic acid, alkenylglutaric acid, and alkenyladipic acid, anhydrides thereof, and monoesters thereof; hydroxy group-containing vinyl-based units, such as acrylic acid or methacrylic acid esters, for example, 2-hydroxyethyl acrylate, 2-hydroxyethyl methacrylate, and 2-hydroxypropyl methacrylate, 4-(1-hydroxy-1-methylbutyl) styrene, and 4-(1-hydroxy-1-methylhexyl) styrene; ester units composed of acrylic acid esters, including acrylic acid esters, such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; ester units composed of a methacrylic acid esters, including α-methylene aliphatic monocarboxylic acids, such as cyclohexyl methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate. A plurality of these may be used.

The dispersing agent can be obtained by known methods, such as the reaction between these polymers or the reaction between a monomer of one polymer and the other polymer.

### Colorant

The toner particle may contain a colorant. Examples of the colorant may include the following.

Examples of black colorants may include carbon black; and those color-matched to black using yellow colorants, magenta colorants and cyan colorants. Although the colorant may contain a pigment alone, it is more preferable to use a dye and a pigment in combination to enhance the color definition thereof in view of the image quality of full-color images.

Examples of magenta toner pigments may include the following pigments. C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; C.I. Pigment Red 1, 2, 10, 13, 15, 23, 29, and 35.

Examples of magenta toner dyes may include the following. C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; Oil-soluble dyes like C.I. Disperse Violet 1, C.I. Basic Red 1, 2, 9, 12, 13, 14, 15, 17, 18, 22, 23, 24, 27, 29, 32, 34, 35, 36, 37, 38, 39, and 40; and Basic dyes, e.g., C.I. basic violet 1, 3, 7, 10, 14, 15, 21, 25, 26, 27, and 28.

Examples of cyan toner pigments may include the following pigments. C.I. Pigment Blue 2, 3, 15:2, 15:3, 15:4, 16, and 17; C.I. Vat Blue 6; C.I. Acid Blue 45, and copper phthalocyanine pigments in which from 1 to 5 phthalimide methyl groups are substituted on the phthalocyanine backbone.

Examples of cyan toner dyes may include C.I. Solvent Blue 70.

Examples of yellow toner pigments may include the following pigments. C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of yellow toner dyes may include C.I. Solvent Yellow 162.

The content of the colorant is preferably from 0.1 to 30 parts by mass relative to 100 parts by mass of the binder resin.

### Charge Control Agent

The toner particle may optionally contain a charge control agent. As the charge control agent to be contained in the toner, known agents can be used. In particular, metal compounds of aromatic carboxylic acids, which are colorless, can charge the toner at a high speed, and can stably retain a certain level of charge amounts, are preferable.

Examples of negative charge control agents may include metal salicylate compounds, metal naphthoate compounds, dicarboxylic acid metal compounds, polymer-type compounds having sulfonic acid or carboxylic acid in the side chain, polymer-type compounds having sulfonate or sulfonic acid ester in the side chain, polymer-type compounds having carboxylate or carboxylic acid esterified portion in the side chain, boron compounds, urea compounds, silicon compounds, and calixarene. Examples of positive charge control agents may include quaternary ammonium salts, high molecular weight compounds having quaternary ammonium salts in the side chain; guanidine compounds, and imidazole compounds. The charge control agent may be internally or externally added to the toner particle. The amount of the charge control agent added is preferably from 0.05 to 10 parts by mass relative to 100 parts by mass of the binder resin.

### Inorganic Fine Particle

The toner may optionally contain an inorganic fine particle. The inorganic fine particle may be internally added to the toner particle or mixed with the toner particle as an external additive. As an external additive, inorganic fine powder, such as silica, titanium dioxide, and aluminum oxide, is preferable. The inorganic fine powder is preferably hydrophobized with a hydrophobic agent, such as a silane compound, a silicone oil, or a mixture thereof.

The external additive for improving the flowability is preferably an inorganic fine powder having a specific surface area of from 50 m²/g to 400 m²/g. To stabilize the durability, inorganic fine powder with a specific surface area of from 10 m²/g to 50 m²/g is preferable. To achieve both improved flowability and stable durability, inorganic fine powder with a specific surface area in the above range may be used in combination.

The external additive is preferably used in an amount from 0.1 to 10.0 parts by mass relative to 100 parts by mass of a toner particle. The toner particle and the external additive may be mixed using a known mixer, such as a Henschel mixer.

### Developer

The toner can also be used as a one-component developer, but it is preferable to mix the toner with a magnetic carrier and use the resulting mixture as a two-component developer to further improve dot reproducibility and to supply stable images over a long period of time.

When the toner is mixed with a magnetic carrier, and the resulting mixture is used as a two-component developer, the mixing ratio of the magnetic carrier at that time is preferably 2 to 15 mass %, and more preferably 4 to 13 mass % or less, as the toner concentration in the two-component developer.

### Magnetic Carrier

As the magnetic carrier, generally known ones, for example, iron oxide; metal particles of iron, lithium, calcium, magnesium, nickel, copper, zinc, cobalt, manganese, chromium, strontium, or a rare earth component, and an alloy particle thereof or an oxide particle thereof; magnetic bodies such as ferrite or magnetite; and a magnetic body-dispersed resin carrier (so-called resin carrier) containing the magnetic body and a binder resin that holds the magnetic body in a dispersed state; magnetic carriers in the form of ferrite or magnetite particles with pores filled with a resin may be used.

As the magnetic carrier, the magnetic body mentioned above may be directly used, or a magnetic body in which the surface of the magnetic body mentioned above as a core is coated with a resin may be used. From the viewpoint of improving the charging performance of the toner, it is preferable to use a magnetic body as the magnetic carrier, in which the surface of the magnetic body mentioned above, as a core, is coated with a resin.

A resin for coating the core is not particularly limited, and known resins may be selected and used, as long as the toner characteristics are not impaired. For example, resins, such as a (meth)acrylic resin, a silicone resin, a urethane resin, polyethylene, polyethylene terephthalate, polystyrene, and a phenol resin, or a copolymerized polymer and a polymer mixture containing these resins may be used. In particular, it is preferable to use a (meth)acrylic resin or a silicone resin from the viewpoint of charging characteristics and preventing adhesion of foreign matter to the carrier particle surfaces. In particular, a (meth)acrylic resin having alicyclic hydrocarbon groups, such as a cyclohexyl group, a cycloheptyl group, a cyclooctyl group, a cyclopentyl group, a cyclobutyl group, or a cyclopropyl group, are particularly preferable form because the surface (coating film surface) of the resin coat layer coating the surface of the magnetic body becomes smooth, and adhesion of toner-derived components, such as a binder resin, a release agent, and an external additive, can be suppressed.

### Production Method

A method for producing a toner particle is not particularly limited, and a known method, such as a pulverization method, a suspension polymerization method, a dissolution suspension method, an emulsion aggregation method, or a dispersion polymerization method, can be used.

Hereinafter, a toner production procedure in the pulverization method will be described.

In the raw material mixing step, materials that constitute the toner particle, such as a crystalline polyester resin, an amorphous polyester resin, and optionally other components, including a release agent, a colorant, and a charge control agent, are weighed out in predetermined amounts, then blended and mixed. Examples of mixing devices may include a Double Cone Mixer, a V-type mixer, a drum-type mixer, a super mixer, a Henschel mixer, a Nauta mixer, and a Mechano hybrid (manufactured by Nippon Coke & Engineering Co., Ltd.).

Then, the mixed material is melted and kneaded to disperse wax or the like in a binder resin. The kneading discharge temperature can be adjusted as appropriate depending on the binder resin and colorant used, but generally, it is preferably 100° C. to 180° C. In the melt kneading step, a batch kneader, such as a pressurizing kneader or a Banbury mixer, and a continuous kneader may be used, and single-screw or twin-screw extruders have become the mainstream because of the superiority of continuous production.

For example, a KTK-type twin-screw extruder (manufactured by Kobe Steel, Ltd.), a TEM-type twin-screw extruder (manufactured by Toshiba Machinery Corp.), a PCM kneader (manufactured by Ikegai Corp.), a twin-screw extruder (manufactured by KCK Engineering K.K.), a co-kneader (manufactured by BUSS), and Niedex (manufactured by Nihon Coke & Engineering Co., Ltd.) may be mentioned. In addition, the resin composition obtained by melt-kneading may be rolled with two rollers and cooled with water in a cooling step.

Next, the cooled resin composition is pulverized to a desired particle diameter in the pulverizing step. In the pulverizing step, for example, after coarsely pulverizing the cooled resin composition in a pulverizer, such as a crusher, a hammer mill, or a feathermill, fine pulverizing is performed additionally in, for example, Krypton system (manufactured by Kawasaki Heavy Industries, Ltd.), Super Rotor (manufactured by Nisshin Engineering Inc.), Turbo mill (manufactured by Freund-Turbo Corp.), or an air jet type fine pulverizer.

Then, as necessary, classification may be performed using a classifier such as inertial classification-system Elbow Jet (manufactured by Nittetsu Mining Co., Ltd.), centrifugal classification system Turboplex (manufactured by Hosokawa Micron Corp.), TSP separator (manufactured by Hosokawa Micron Corp.), or Faculty (manufactured by Hosokawa Micron Corp.), or a sieving machine to obtain a classified product (toner particle).

The toner particle may be used as a toner as is. A toner may be obtained by applying an external additive to the surface of the toner particle as necessary. Examples of methods of applying an external additive according to an external addition treatment may include a method in which a toner particle and various known external additives are blended in predetermined amounts, and stirred and mixed using a mixing device such as a Double Cone Mixer, a V-type mixer, a drum type mixer, a super mixer, a Henschel mixer, a Nauta mixer, a Mechano hybrid (manufactured by Nippon Coke & Engineering. Co., Ltd.), or Nobilta (manufactured by Hosokawa Micron Corp.) as an external addition machine.

Next, a method of measuring each physical property will be described. Measurement of Average Area Ratio, Number Average of Long Axis lengths, and Average Aspect Ratio of Crystals of Crystalline Polyester Resin Evaluation of Dispersion State of Crystals of Crystalline Polyester Resins in Samples A and B by TEM

The observation of the cross-sections of the samples A and B by transmission electron microscopy (TEM) and evaluation of the crystals of the crystalline polyester resin may be carried out as follows. The preparation procedures of the sample A and sample B were as follows.

The sample A is produced in the following procedure. An Os film (5 nm) and a naphthalene film (20 nm) are formed on a toner as protective films using an osmium plasma coater (OPC 80T, Filgen, Inc.), and the toner is embedded in a photo-curable resin D800 (JEOL Ltd.). Then, the sample A is prepared using a differential scanning calorimeter “DSC 7020” (manufactured by Hitachi High-Tech Corp.). The sample, placed in an aluminum pan, is introduced into the apparatus set at 25° C., and the temperature is then raised to 150° C. at a ramp rate of 10° C./min. After holding the sample for 5 min to melt the toner, the toner is cooled to 25° C. at a rate of 100° C./min to obtain a sample A.

A sample A is collected, taken out from an aluminum pan, a cross-section is observed by the method described later, and a number average D_{A} of the long axis lengths of crystals of the crystalline polyester resin, and an average area ratio S_{A} are measured.

The sample B is prepared from the sample A prepared by the above method with a blower constant temperature controller “DFN600” (manufactured by Yamato Scientific Co., Ltd.). The sample A is placed in an apparatus set at 50° C. and allowed to stand for 72 hours, and then collected to obtain a sample B. Cross-section of the resulting sample B is observed by the method described later, and a number average D_{B} of the long axis lengths, an average aspect ratio, and an average area ratio S_{B} of the crystalline polyester resin crystals are measured.

The crystalline polyester resin can be obtained as a clear contrast by dyeing the cross section of the sample A or the sample B with ruthenium. The crystalline polyester resin is dyed more weakly than the organic components that constitute the inside of the toner. It is believed that the dyeing material penetrates the crystalline polyester resin to be weaker than the organic component in the toner because of the difference in density.

Because the amount of ruthenium atoms varies depending on the intensity of staining, a strongly stained part has many of the atoms in black on the observed image without transmitting electron beams, whereas a weakly stained part is likely to transmit electron beams and thus in white on the observed image.

The sample A or sample B is cut to expose the sample cross-section with a thickness of 60 nm (or 70 nm) at a cutting speed of 1 mm/s using an ultrasonic ultramicrotome (UC7, Leica).

The obtained cross-section is dyed for 15 minutes in a 500 Pa atmosphere of RuO₄ gas using a vacuum electron dyeing apparatus (VSC 4R 1H, manufactured by Filgen, Inc.), and STEM observation is performed using a TEM (JEM 2800, JEOL Ltd.) in a STEM mode. The probe size of STEM was 1 nm, and an image was acquired with a resolution of 1024×1024 pixels.

The obtained image is binarized (threshold 120/255 stages) by an image processing software “Image-Pro Plus (Media Cybernetics)”. Since a crystal domain can be extracted by binarization, the size of the crystal domain is measured. Upon cross-sectional observation of 20 randomly selected samples, all the lengths of the long axis and the short axis, which can be measured, of the crystalline domain of the crystalline polyester resin are measured.

From the measured lengths, the number average D_{A}, the number average D_{B}, and the average aspect ratio are calculated.

Furthermore, average area percentages (S_{A}, S_{B}) of the crystals of the crystalline polyester resin on the cross sections of the sample A and the sample B are calculated. The area percentage is calculated from 20 sample cross-sections having longitudinal diameters of 3.0 μm or longer among the randomly selected sample cross-sections. With respect to a measurement range, a range that does not extend to the embedding resin in the cross-section (100 nm inside from the interface with the embedding resin) is selected, the total area ratio of the domains of the crystalline polyester resin within the selected range in the area of the observation range is calculated, and the arithmetical mean value of 20 cross-sections is used.

### Separation of Each Material From Toner

The separation of materials from the toner may be performed by utilizing the difference in solubility in a solvent. An example thereof is shown below. First separation: a toner is dissolved in methyl ethyl ketone (MEK) at 23° C. to separate soluble matters (the amorphous polyester resin) and insoluble components (the crystalline polyester resin, wax, wax dispersing agent, colorant, inorganic fine particle, and the like). Second separation: the insoluble matter (the crystalline polyester resin, wax, wax dispersing agent, colorant, inorganic fine particle, and the like) obtained in the first separation is dissolved in MEK at 100° C. to separate soluble matter (the crystalline polyester resin, wax, and wax dispersing agent) and insoluble matter (colorant and inorganic fine particle).

Third separation: the soluble matter (the crystalline polyester resin, wax, and wax dispersing agent) obtained in the second separation are dissolved in chloroform at 23° C. to separate soluble matter (the crystalline polyester resin) and insoluble matter (wax and wax dispersing agent).

Based on the mass of each material, such as the crystalline polyester resin, separated by the above separation method, the content of each material can be calculated.

In addition, the amorphous polyester resin can be separated into the modified amorphous polyester resin and the amorphous polyester resin B, for example, according to molecular weights by a known means, such as GPC.

### Calculation of Content Ratio of Monomer Units of Modified Amorphous Polyester Resin and Modified Crystalline Polyester Resin

The contents of the constituent monomers in the modified amorphous polyester resin and the modified crystalline polyester resin are calculated according to the following method using NMR.

First, 5 mg of a resin to be measured is weighed, dissolved in THF-d or chloroform-d, and subjected to 1H-NMR measurement, and the compositional ratio is calculated from the integral values of respective peaks. Detailed apparatus conditions are as follows.

### Measurement Conditions

Measurement instrument: JNM-ECA 400 FT-NMR (JEOL)
Measured nuclide: 1H
Solvent: THF-d or chloroform-d
Measurement frequency: 400 MHz
Pulse width: 5.0 μs
Frequency range: 10500 Hz
Accumulation count: 64 times
Measurement temperature: Room temperature

### Measurement of Glass Transition Temperature (Tg) of Resin

The glass transition temperature (Tg) is measured according to ASTM D 3418-82 using a differential scanning colorimeter “Q2000” (manufactured by TA Instruments). The melting points of indium and zinc are used to correct the temperature of a device detection unit, and the heat of fusion of indium is used to correct the amount of heat.

Specifically, 3 mg of a resin or a toner is weighed exactly and placed in an aluminum pan. An empty aluminum pan is used as a reference. Then, the measurement is performed within the measurement temperature range from 30° C. to 200° C. at a ramp rate of 10° C./min. In the measurement, the temperature is raised to 200° C. once, subsequently the temperature is dropped to 30° C., and after that, the temperature is raised again. The specific heat change is obtained in the temperature range from 40° C. to 100° C. during this second temperature-raising process. An intersection between a line of midpoints of baselines before and after the occurrence of the specific heat change and the differential heat curve is defined as the glass transition temperature of the resin.

### Measurement of Melting Point of Modified Crystalline Polyester Resin

The melting point of a modified crystalline polyester resin is measured according to ASTM D 3418-82 using a differential scanning colorimeter “Q2000” (manufactured by TA Instruments).

The melting points of indium and zinc are used to correct the temperature of a device detection unit, and the heat of fusion of indium is used to correct the amount of heat. More specifically, 3 mg of a sample is precisely weighed and placed in aluminum pan, and measurement is performed in the condition below using an empty aluminum pan as a reference.
Ramp rate: 10° C./min
Measurement onset temperature: 30° C.
Measurement end temperature: 180° C.

Measurements are performed within the measurement range from 30° C. to 180° C. at a ramp rate of 10° C./min. The temperature is raised once to 180° C. and kept at the same temperature for 10 minutes, subsequently, the temperature is dropped to 30° C., and after that, the temperature is raised again. A temperature at which the temperature-endothermic quantity curve reaches the maximum endothermic peak within the range from 30° C. to 100° C. in this second temperature-raising process is defined as a melting point.

### Method for Calculating SP Value

The sp values of the modified amorphous polyester resin and the modified crystalline polyester resin are calculated in accordance with a calculation method proposed by Fedors. For an atom or atomic group in the molecular structure, the evaporation energy (Δei) (cal/mol) and the molar volume (Δvi) (cm³/mol) are determined from the table described in “Polym. Eng. Sci., 14 (2), 147-154 (1974)” and (ΣΔei/ΣΔvi)^{0.5} is defined as the SP value (cal/cm³)^{0.5}.

Measurement of Molecular Weight of Amorphous Polyester Resin, such as Weight-Average Molecular Weight of Modified Amorphous Polyester Resin by GPC

The molecular weight distribution of THE soluble matter in an amorphous polyester resin is measured as follows using gel permeation chromatography (GPC).

First, a resin is dissolved in tetrahydrofuran (THF) at room temperature for 24 hours. Then, the obtained solution is filtered through a solvent-resistant membrane filter “Myshori Disk” (manufactured by Tosoh Corp.) with a pore size of 0.2 μm, thereby obtaining a sample solution. It should be noted that the sample solution is adjusted so that the concentration of the component soluble in THF be 0.8 mass %. The sample solution is used to perform measurement under the following conditions.
Apparatus: HLC 8120GPC (detector: RI) (manufactured by Tosoh Corp.)
Column: Seven connected Shodex KF-801, 802, 803, 804, 805, 806, and 807 columns (manufactured by Showa Denko K.K.)
Eluent: Tetrahydrofuran (THF)
Flow rate: 1.0 mL/min.
Oven temperature: 40.0° C.
Sample injection amount: 0.10 mL

In the calculation of the molecular weight of the sample, a molecular weight calibration curve prepared using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corp.) is used.

Molecular Weight Measurement, such as Weight-Average Molecular Weight Mw of Modified Crystalline Polyester Resin by GPC

First, a modified crystalline polyester resin is dissolved in o-dichrolobenzene at room temperature for 24 hours. Then, the obtained solution is filtered through a solvent-resistant membrane filter “Myshori Disk” (manufactured by Tosoh Corp.) having a pore diameter of 0.2 μm to obtain a sample solution. It should be noted that the sample solution is adjusted so that the concentration of the component soluble in THF be 0.8 mass %. The sample solution is used to perform measurement under the following conditions.
Device: HLC-8121GPC/HT (manufactured by Tosoh Corp.)
Column: 2 series of TSKgel GMHHR-HHT 7.8 cm I.D.×30 cm (manufactured by Tosoh Corp.)
Detector: RI for high temperatures
Temperature: 135° C.
Solvent: o-dichlorobenzene (with 0.05% ionol added)
Flow velocity: 1.0 mL/min.
Sample: Inject 0.4 mL of the 0.1% sample

A measurement is performed under the conditions described above, and for the calculation of the molecular weight of a sample, the molecular weight calibration curve prepared with a monodisperse polystyrene standard sample is used. Then, molecular weights are calculated using a polyethylene conversion formula derived from the Mark-Houwink viscosity formula.

### Method of Measuring Softening Temperature

The softening temperature of a sample is measured using a constant load extrusion-type capillary rheometer “Flow characteristic evaluation device Flowtester CFT-500D” (manufactured by Shimadzu Corp.) according to the manual attached to the device. In this device, a constant load is applied from above the measurement sample using a piston, the measurement sample filled in a cylinder is heated and melts, the molten measurement sample is extruded from a die at the bottom of the cylinder, and a flow curve showing the relationship between the amount of piston drop and the temperature in this case can be obtained.

The temperature at which the outflow started and the piston started to descend is defined as the outflow starting temperature, and the “melt temperature in the ½ method” described in the manual attached to the “flow characterization instrument Flowtester CFT-500D” is defined as the softening temperature. The melting temperature in the ½ method is calculated as follows. First, ½ of the difference between the piston descent amount Smax at the point of time when the outflow is finished and the piston descent amount Smin at the point of time when the outflow started is calculated (this difference is taken as X). X=(Smax−Smin)/2). Thus, the temperature on the flow curve when the piston descent amount is the sum of X and Smin is the melting temperature in the ½ method.

A measurement sample is obtained by compression-molding 1.0 g of the resin under an environment of 25° C. using a tablet press (for example, NT-100H, manufactured by NPa System Co., Ltd.) at 10 MPa for 60 seconds to achieve a cylindrical shape with a diameter of approximately 8 mm.
The measurement conditions for CFT-500D are as follows.
Test mode: Temperature-rising method
Start temperature: 50° C.
Saturated temperature: 200° C.
Measurement interval: 1.0° C.
Ramp rate: 4.0° C./min
Piston cross-sectional area: 1.000 cm²
Test load (piston load): 10.0 kgf (0.9807 MPa)
Preheating time: 300 seconds
Diameter of hole of die: 1.0 mm
Length of die: 1.0 mm

### Method of Measuring Weight-Average Particle Diameter (D4) of Toner Particle

The weight-average particle diameter (D4) of the toner is calculated as follows. A particle counting analyzer “CDA-1000X” (manufactured by SYSMEX Corp.) in accordance with a pore electrical resistance method, including an aperture tube of 100 μm, is used as a measurement apparatus. Appended dedicated software “CDA-1000X (manufactured by SYSMEX Corp.)” is used for setting the measurement conditions and analyzing measurement data.

The electrolytic solution used for the measurement can be, for example, “Cellpack” (made by Sysmex Corp.). Before measurement and analysis, the dedicated software was set up as follows. On the “measurement condition setting” screen of the dedicated software, the total count number is set to 50000, the number of repeated measurements is set to 1, and the measurement mode is set to the total count (no limit).

The specific measurement method is as follows.
(1) 150 mL of an electrolyte aqueous solution is put into a special glass round-bottom beaker, which is set on a sample stage, and stirred with a stirring propeller at 500 rpm. Then, the “blank check measurement” of the dedicated software is clicked to start the measurement, and that the count number is less than 500 is confirmed. If the count number is 500 or more, the beaker and the aperture tube are repeatedly washed.
(2) The aqueous electrolytic solution: 30 mL is put into a 100 mL flat-bottom glass beaker. To this solution, 0.3 mL of a diluted solution prepared by diluting “Contaminon N” (a 10 mass % aqueous solution of a neutral detergent with pH 7 for washing precision measurement instruments, including a nonionic surfactant, an anionic surfactant, and an organic builder, manufactured by Wako Pure Chemical Industries, Ltd.) with ion exchanged water to 3 times by mass is added as a dispersing agent.
(3) An ultrasonic disperser “Ultrasonic Dispersion System Tetra 150” (manufactured by Nikkaki Bios Co., Ltd.), which incorporates two oscillators with an oscillation frequency of 50 kHz with their phases shifted 180 degrees and has an electrical output of 120 W, is prepared. 3.3 L of deionized water is put into the water tank of the ultrasonic disperser, and 2 mL of Contaminon N is added to this water tank.
(4) The beaker in (2) is set in a beaker fixing hole of the ultrasonic disperser, and the ultrasonic disperser is operated. Then, the height position of the beaker is adjusted so as to maximize the resonance state of the liquid surface of the aqueous electrolytic solution in the beaker.
(5) While the aqueous electrolytic solution in the beaker in (4) is irradiated with ultrasonic waves, 10 mg of the toner is added little by little and dispersed. Then, the ultrasonic dispersion treatment is continued for an additional 60 seconds. Furthermore, for the ultrasonic dispersion, the water temperature in the water tank is appropriately adjusted to be in a range from 10° C. to 40° C.
(6) To the round-bottom beaker in (1) placed in the sample stand, the aqueous electrolytic solution in (5) in which the toner is dispersed is added dropwise with a pipette, and the measurement concentration is adjusted to be 6%. Then, the measurement is performed until the number of measurement particles reaches 50000.
(7) The measurement data is analyzed using a dedicated software attached to the device, and the weight-average particle diameter (D4) is calculated.

### Method of Measuring Acid Value

An acid value is the mass [mg] of potassium hydroxide required to neutralize acids contained in 1 g of a sample. That is, the mass [mg] of potassium hydroxide required for neutralizing free fatty acids and resin acids contained in 1 g of a sample is called an acid value.

The acid value was measured according to JIS K 0070-1992. Specifically, the acid value is measured in accordance with the following procedure.

### (1) Preparation of Reagent

1.0 g of phenolphthalein was dissolved in 90 mL of ethyl alcohol (95 vol %), deionized water was added so that the amount be 100 mL, thereby preparing a phenolphthalein solution.

7 g of special-grade potassium hydroxide was dissolved in 5 mL of water, and ethyl alcohol (95 vol %) was added to bring the volume to 1 L. To prevent contact with carbon dioxide gas and the like, the mixture was placed in an alkali-resistant container and left for 3 days. After standing, the mixture was filtered to obtain a potassium hydroxide solution. The obtained potassium hydroxide solution was stored in an alkali-resistant container. The factor of the potassium hydroxide solution was determined based on the amount of the potassium hydroxide solution required for neutralization when 25 mL of 0.1 mol/L hydrochloric acid was placed in an Erlenmeyer flask, several drops of the phenolphthalein solution were added, and the titration with the potassium hydroxide solution was performed. The above 0.1 mol/L hydrochloric acid was prepared according to JIS K 8001-1998.

### (2) Operation

### (A) Main Test

2.0 g of a sample was weighed exactly in an Erlenmeyer 200 mL flask, 100 mL of a mixed solution of toluene/ethanol (2:1) was added thereto, and the sample was dissolved over 5 hours. Next, several drops of the phenolphthalein solution were added as an indicator, and titration was performed using the potassium hydroxide solution. Note that the endpoint of the titration is when the light red color of the indicator persists for about 30 seconds.

### (B) Blank Test

The titration was performed by the same operation as above, except that no sample was added (that is, only a mixed solution of toluene/ethanol (2:1) was used).

### (3) Calculation of Acid Value

The obtained result was substituted into the following expression to calculate the acid value.

$$AV = [ ( B - A ) \times f \times 5.61 ] / S$$

In the expression, AV indicates an acid value [mgKOH/g], A indicates the amount [mL] of the potassium hydroxide solution added in the blank test, B indicates the amount [mL] of the potassium hydroxide solution added in the main test, f indicates the factor of the aqueous potassium hydroxide solution, and S indicates the mass [g] of a sample.

### Method of Measuring Hydroxyl Value

The hydroxyl value is the number of milligrams of potassium hydroxide required to neutralize acetic acid bonded to a hydroxyl group when 1 g of a sample is acetylated. The hydroxyl value of the binder resin is measured according to JIS K 0070-1992. Specifically, the hydroxyl value of the binder resin is measured according to the following procedure.

### (1) Preparation of Reagent

25 g of special-grade acetic anhydride is placed in a 100 mL volumetric flask, then pyridine is added to make a total volume of 100 mL, and the mixture is thoroughly shaken to obtain an acetylation reagent. To prevent contact with moisture, carbon dioxide gas, and the like, the obtained acetylation reagent is stored in a brown bottle.

1.0 g of phenolphthalein is dissolved in 90 mL of ethyl alcohol (95 vol %), and ion exchanged water is added to adjust the volume to 100 mL to obtain a phenolphthalein solution.

35 g of special grade potassium hydroxide is dissolved in 20 mL of water, and ethyl alcohol (95 vol %) is added to adjust the volume to 1 L. The resulting solution is placed in an alkali-resistant container to prevent contact with carbon dioxide gas or the like, allowed to stand for 3 days, and then filtered to obtain a potassium hydroxide solution. The obtained potassium hydroxide solution is stored in an alkali-resistant container. The factor of the potassium hydroxide solution is determined from the amount of the potassium hydroxide solution required for neutralization by placing 25 mL of 0.5 mol/L hydrochloric acid in an Erlenmeyer flask, adding several drops of the phenolphthalein solution, and titrating with the potassium hydroxide solution. The 0.5 mol/l hydrochloric acid is prepared according to JIS K 8001-1998.

### (2) Operation

### (A) Main Test

1.0 g of a sample is weighed exactly in a 200 mL round-bottom flask, and 5.0 mL of the acetylating reagent is accurately added thereto using a whole pipette. In this case, when the sample does not easily dissolve in the acetylation reagent, a small amount of special-grade toluene is added to dissolve the sample.

A small funnel is placed at the mouth of the flask, and approximately 1 cm of the bottom of the flask is immersed and heated in a glycerin bath at about 97° C. In this case, to prevent the temperature of the neck of the flask from increasing due to the heat of the bath, it is preferable to cover the base of the neck of the flask with a piece of heavy paper with a round hole.

After 1 hour, the flask is removed from the glycerin bath and cooled. After cooling, 1 mL of water is added through the funnel and shaken to hydrolyze acetic anhydride. For more complete hydrolysis, the flask is heated again in the glycerin bath for 10 minutes. After allowing to cool, the funnel and flask walls are washed with 5 mL of ethyl alcohol.

Several drops of the phenolphthalein solution are added as an indicator, and titration is performed using the potassium hydroxide solution. Note that the endpoint of the titration is when a light red color of the indicator persists for about 30 seconds.

### (B) Blank Test

Titration is performed in the same manner as the above operation except that no sample is used.
(3) The obtained result is substituted into the following expression to calculate the hydroxyl value.

$$A = [ \{ ( B - C ) \times 28.05 \times f \} / S ] + D$$

Here, A: hydroxyl value (mgKOH/g), B: amount of the potassium hydroxide solution added in the blank test (mL), C: amount of the potassium hydroxide solution added in the main test (mL), f: factor of the potassium hydroxide solution, S: sample (g), D: acid value of the sample (mgKOH/g).

Method for Calculating Modification Rate with Linear Alkyl Compound of Molecular Chain Terminal of Modified Amorphous Polyester Resin or Modified Crystalline Polyester Resin

The modification rate with a linear alkyl compound at the molecular chain terminals of a modified amorphous polyester resin or a modified crystalline polyester resin (hereinafter referred to as a resin in the calculation method) is calculated using the acid value, hydroxyl value, and the molecular weight determined as above. Specifically, the molar number of terminal functional groups (carboxy group or hydroxy group left without condensation of the linear alkyl compound) per gram of a resin is calculated using the following expression.

$$Molar number of terminal functional groups = ( acid value + hydroxyl value ) / ( 1000 \times 56.105 )$$

Next, the molar number per gram of a resin is calculated from the number average molecular weight Mn of the resin.

$$Molar number per gram of a resin = 1 / M n$$

The amount of functional groups at the terminal is calculated from the ratio of monomer units in the resin, calculated by NMR. Specifically, in the case of an ester product of a dicarboxylic acid and a dialcohol, the number of functional groups is 2. When a trivalent or further polyvalent monomer is used, the amount of functional group at the terminal may be calculated from the molar ratio.

$$Modification rate with a linear alkyl compound at molecular chain terminals of a resin ( mol \% ) = [ 1 - ( Molar number of terminal functional groups ) / ( Molar number per gram of a resin ) \times ( Amount of functional groups ) ] \times 100$$

### EXAMPLES

The following examples and other information will illustrate this disclosure. However, the description regarding these examples is not intended to limit the present disclosure. Note that unless otherwise particularly specified, “part(s)” in the formulation below are on a mass basis.

### Production Example of Amorphous Polyester Resin A1

Bisphenol A/propylene oxide adduct (an average number of moles added of 2.2 mol): 78.0 parts by mass
Terephthalic acid: 20.0 parts by mass
Titanium tetrabutoxide (esterification catalyst): 0.5 parts by mass

The above materials were weighed out in a reaction vessel equipped with a cooling tube, a stirrer, a nitrogen inlet tube, and a thermocouple. Next, the inside of the flask was purged with nitrogen gas, the temperature was then gradually raised with stirring, and the reaction was allowed to proceed for 2 hours while stirring at a temperature of 200° C. After the pressure in the reaction vessel was lowered to 8.3 kPa and kept at the same conditions for 1 hour, the reaction vessel was cooled down to 160° C. and returned to atmospheric pressure.
Stearic acid: 2.0 parts by mass

After that, the material mentioned above was added, then the pressure in the reaction vessel was lowered to 8.3 kPa, and the reaction was initiated while maintaining the temperature at 200° C. After confirming that the softening temperature reached the temperature shown in Table 1, the temperature was lowered to stop the reaction to obtain an amorphous polyester resin A1. Physical properties are shown in Table 1.

### Production Example of Amorphous Polyester Resins A2 to A14

Amorphous polyester resins A2 to A14 were obtained in the same manner as in the production example of the amorphous polyester resin A1, except that the monomers used were changed as listed in Table 1. The composition and physical properties of the obtained amorphous polyester resins A2 to A14 are shown in Table 1.

The amorphous polyester resins A1 to A14 had a degree of crystallinity of 10% or less when allowed to stand at 30° C. and 80% RH for 1 week.

The polyester resins A1 to A11 were modified amorphous polyester resins.

TABLE 1

| | | | | | | | Physical properties | | | | | |
|---|---|---|---|---|---|---|---|---|---|---|---|---|
| Amorphous | Polymerizable | | Polymerizable | | Polymerizable | | | Softening | | | | |
| polyester | monomer 1 | | monomer 2 | | monomer 3 | | Tg | temperature | | | SP | Modification |
| resin A | Type | Parts | Type | Parts | Type | Parts | ° C. | ° C. | Mn | Mw | value | rate |
| 1 | BPO-PO | 78.0 | TPA | 20.0 | SA | 2.0 | 48 | 94 | 2200 | 6300 | 10.8 | 3 |
| 2 | BPO-PO | 78.0 | TPA | 20.0 | BA | 2.0 | 47 | 94 | 2200 | 6300 | 10.8 | 2 |
| 3 | BPO-PO | 76.0 | TPA | 20.0 | SA | 4.0 | 47 | 93 | 2200 | 6300 | 10.8 | 6 |
| 4 | BPO-PO | 78.0 | TPA | 21.0 | SA | 1.0 | 49 | 95 | 2200 | 6300 | 10.9 | 1 |
| 5 | BPO-PO | 74.0 | TPA | 20.0 | SA | 6.0 | 47 | 92 | 2200 | 6300 | 10.7 | 8 |
| 6 | BPO-PO | 78.0 | TPA | 20.0 | PA | 2.0 | 48 | 94 | 2200 | 6300 | 10.8 | 3 |
| 7 | BPO-PO | 78.0 | TPA | 20.0 | LA | 2.0 | 48 | 94 | 2200 | 6300 | 10.8 | 2 |
| 8 | BPO-PO | 78.0 | TPA | 20.0 | SAI | 2.0 | 48 | 94 | 2200 | 6300 | 10.8 | 3 |
| 9 | BPO-PO | 78.0 | TPA | 21.5 | SA | 0.5 | 49 | 97 | 2200 | 6300 | 10.9 | 1 |
| 10 | BPO-PO | 78.0 | TPA | 20.0 | MA | 2.0 | 49 | 95 | 2200 | 6300 | 10.8 | 3 |
| 11 | BPO-PO | 78.0 | TPA | 20.0 | CA | 2.0 | 49 | 95 | 2200 | 6300 | 10.8 | 2 |
| 12 | BPO-PO | 80.0 | TPA | 20.0 | — | — | 52 | 100 | 2200 | 6300 | 10.8 | — |
| 13 | BPO-PO | 75.0 | TPA | 18.0 | DS | 7.0 | 53 | 94 | 2200 | 6500 | 10.7 | — |
| 14 | BPO-PO | 80.0 | TPA | 20.0 | — | — | 59 | 100 | 2000 | 6000 | 10.9 | — |

In Table 1, Tg indicates a glass transition temperature. The unit of SP values is (cal/cm³)^{0.5}. The modification rate is a modification rate (mol %) with a linear alkyl compound at molecular chain terminals.

The abbreviations in Table 1 are as follows. The numerical values in parentheses refer to the carbon number of linear chain alkyl compounds.
BPA-PO: Bisphenol A propylene oxide adduct (an average number of moles added of 2.2 mol)
TPA: Terephthalic acid:
PA: Palmitic acid (16)
SA: Stearic acid (18)
BA: Behenic acid (22)
LA: Lignoseric acid (24)
MA: Myristic acid (14)
CA: Cerotic acid (26)
SAI: Stearyl alcohol (18)
DS: Dodecyl succinic anhydride

### Production Example of Amorphous Polyester Resin B1

Bisphenol A propylene oxide adduct (an average number of moles added of 2.2 mol): 60.0 parts by mass
Terephthalic acid: 35.0 parts by mass
Trimellitic anhydride: 5.0 parts by mass
Titanium tetrabutoxide (esterification catalyst): 0.5 parts by mass

The above materials were weighed out in a reaction vessel equipped with a cooling tube, a stirrer, a nitrogen inlet tube, and a thermocouple. Next, the inside of the flask was purged with nitrogen gas, the temperature was then gradually raised with stirring, and the reaction was allowed to proceed for 3 hours while stirring at a temperature of 200° C. After that, the pressure in the reaction vessel was lowered to 8.3 kPa, and the reaction was initiated while maintaining a temperature of 200° C. After confirming that the softening temperature had reached 138° C., the temperature was lowered to stop the reaction and obtain an amorphous polyester resin, B1. Physical properties are shown in Table 2.

TABLE 2

| Amorphous | Polymerizable | | Polymerizable | | Polymerizable | | Physical properties | | | |
|---|---|---|---|---|---|---|---|---|---|---|
| polyester | monomer 1 | | monomer 2 | | monomer 3 | | Tg | | | SP |
| resin B | Type | Parts | Type | Parts | Type | Parts | ° C. | Mn | Mw | value |
| 1 | BPO-PO | 60.0 | TPA | 35.0 | TMA | 5.0 | 58 | 4300 | 10500 | 10.8 |

In Table 2, Tg indicates a glass transition temperature. The unit of the SP value is (cal/cm³)^{0.5}. The abbreviations in Table 2 are as follows.
BPA-PO: Bisphenol A propylene oxide adduct (an average number of moles added of 2.2 mol)
TPA: Terephthalic acid:
TMA: Trimellitic anhydride

### Production Example of Crystalline Polyester Resin 1

Ethylene glycol: 20.0 parts by mass
Tetradecanedioic acid: 74.0 parts by mass
Behenic acid: 6.0 parts by mass
Tin 2-ethylhexanoate: 0.5 parts by mass

The above materials were weighed out in a reaction vessel equipped with a cooling tube, a stirrer, a nitrogen inlet tube, and a thermocouple. The inside of the flask was purged with nitrogen gas, the temperature was then gradually raised with stirring, and the reaction was allowed to proceed for 3 hours while stirring at a temperature of 140° C.

Next, the pressure in the reaction vessel was lowered to 8.3 kPa, and the reaction was continued for 4 hours while maintaining the temperature at 200° C. to obtain a crystalline polyester resin 1. Physical properties are shown in Table 3.

### Production Example of Crystalline Polyester Resins 2 to 16

Crystalline polyester resins 2 to 16 were obtained in the same manner as in the production example of the crystalline polyester resin 1, except that the monomers used were changed as listed in Table 3. The composition and physical properties of the obtained crystalline polyester resins 2 to 16 are listed in Table 3.

The crystalline polyester resins 1 to 14 and 16 are modified crystalline polyester resins.

TABLE 3

| | | | | | | | Physical properties | | | | |
|---|---|---|---|---|---|---|---|---|---|---|---|
| Crystalline | First | | Second | | Third | | Melting | | | | |
| polyester | monomer unit | | monomer unit | | monomer unit | | point | | | SP | Modification |
| resin No | Type | Parts | Type | Parts | Type | Parts | ° C. | Mn | Mw | value | rate |
| 1 | EG | 20.0 | TDA | 74.0 | BA | 6.0 | 90 | 4700 | 19000 | 9.8 | 50 |
| 2 | EG | 20.0 | TDA | 74.0 | SA | 6.0 | 90 | 4700 | 19000 | 9.7 | 58 |
| 3 | EG | 20.0 | TDA | 74.0 | BA | 6.0 | 88 | 3900 | 15000 | 9.8 | 37 |
| 4 | EG | 20.0 | TDA | 74.0 | BA | 6.0 | 92 | 5500 | 25000 | 9.8 | 62 |
| 5 | EG | 20.0 | TDA | 74.0 | BA | 6.0 | 88 | 3800 | 13000 | 9.8 | 34 |
| 6 | EG | 20.0 | TDA | 74.0 | BA | 6.0 | 92 | 5600 | 28000 | 9.8 | 73 |
| 7 | EG | 18.0 | TDA | 74.0 | BA | 10.0 | 91 | 4700 | 19000 | 9.5 | 62 |
| 8 | EG | 26.0 | DDA | 72.0 | BA | 2.0 | 85 | 4700 | 19000 | 10.1 | 20 |
| 9 | EG | 20.0 | TDA | 74.0 | PA | 6.0 | 90 | 4700 | 19000 | 9.8 | 66 |
| 10 | EG | 20.0 | TDA | 74.0 | LA | 6.0 | 90 | 4700 | 19000 | 9.9 | 43 |
| 11 | EG | 20.0 | TDA | 74.0 | BAI | 6.0 | 90 | 4700 | 19000 | 9.8 | 50 |
| 12 | EG | 20.0 | TDA | 74.0 | BA | 6.0 | 87 | 2500 | 9000 | 9.8 | 40 |
| 13 | EG | 20.0 | TDA | 74.0 | MA | 6.0 | 90 | 4700 | 19000 | 9.9 | 66 |
| 14 | EG | 20.0 | TDA | 74.0 | CA | 6.0 | 90 | 4700 | 19000 | 9.9 | 40 |
| 15 | EG | 22.0 | TDA | 78.0 | — | — | 88 | 4700 | 19000 | 9.9 | — |
| 16 | HG | 18.0 | DDA | 82.0 | SA | 4.0 | 84 | 8000 | 27000 | 9.7 | 25 |

In Table 3, the unit of the SP value is (cal/cm³)^{0.5}. The modification rate is a modification rate (mol %) with a linear alkyl compound at molecular chain terminals.

The abbreviations in Table 3 are as follows. The numerical values in parentheses indicate the carbon number of a linear chain alkyl compound.
EG: Ethylene glycol
HG: 1,6-Hexanediol
TDA: Tetradecanedioic acid
DDA: Dodecanedioic acid
PA: Palmitic acid (16)
SA: Stearic acid (18)
BA: Behenic acid (22)
LA: Lignoseric acid (24)
MA: Myristic acid (14)
CA: Cerotic acid (26)
BAI: Behenyl alcohol (22)

### Production of Wax Dispersing Agent

Low molecular weight polypropylene (Biscol 660P manufactured by Sanyo Chemical Industries, Ltd.)
10.0 parts by mass (0.02 mol; 2.4 mol % relative to the total number of moles of constituent monomers)
Xylene: 25.0 parts by mass

The above materials were weighed out in a reaction vessel equipped with a cooling tube, a stirrer, a nitrogen inlet tube, and a thermocouple. Next, the inside of the flask was purged with nitrogen gas, and the temperature was gradually raised to 175° C. with stirring.
Styrene: 68.0 parts by mass
Cyclohexyl methacrylate: 5.0 parts by mass
Butyl acrylate: 12.0 parts by mass
Methacrylic acid: 5.0 parts by mass
Xylene: 10.0 parts by mass
Di-t-butylperoxyhexahydroterephthalate: 0.5 parts by mass

Thereafter, the above materials were added dropwise over a period of 3 hours and stirred for another 30 minutes. The solvent was then removed by evaporation to obtain a wax dispersing agent having a structure in which a vinyl resin component and a hydrocarbon compound were reacted with each other. The resulting wax dispersing agent had a peak molecular weight Mp of 6000 and a softening temperature of 125° C.

### Production Example of Toner Particle 1

Amorphous polyester resin A1:50.0 parts by mass
Amorphous polyester resin B1:21.0 parts by mass
Crystalline polyester resin 1:12.0 parts by mass
Wax dispersing agent: 5.0 parts by mass
Fischer-Tropsch wax (hydrocarbon wax, melting point: 90° C.): 5.0 parts by mass
C.I. pigment Blue 15:3: 7.0 parts by mass

The above material was mixed using a Henschel mixer (FM-75 model, manufactured by Nihon Coke & Engineering Co., Ltd.) at a number of revolutions of 20 s⁻¹ for a rotation time of 5 min and then kneaded using a twin screw kneader (PCM-30, manufactured by Ikegai Corp.) at a number of revolutions of the screw of 250 rpm and a discharge temperature of 130° C. The resulting kneaded product was rolled and cooled in a drum flaker (MBD 30-30, manufactured by Nihon Coke & Engineering Co., Ltd.). The temperature of the cooling water was set to 50° C., and the conditions were set so that the thickness of the resin composition after rolling would be 1.0 mm. After that, the resin composition after rolling was kept at 40° C. to 50° C. for 60 minutes. The resulting resin composition was cooled to room temperature and then roughly pulverized to a particle size of 1 mm or smaller using a hammer mill to obtain a roughly pulverized substance. The resulting roughly pulverized substance was finely pulverized by a mechanical pulverizer (T-250, manufactured by Freund-Turbo Corp.).

In addition, classification was performed using Faculty F-300 (manufactured by Hosokawa Micron Corp.) to obtain a toner particle 1 having a weight-average particle diameter of 6.0 μm. The operating conditions were set such that the number of revolutions of the classification rotor would be 130 s⁻¹ and the number of revolutions of the dispersion rotor would be 120 s⁻¹.

### Production Examples of Toner Particles 2 to 32

Toner particles 2 to 32 were obtained in the same manner as in the Production Example of a toner particle 1, except that the types and parts by mass of the amorphous polyester resin A, the amorphous polyester resin B, and the crystalline polyester resin were changed as listed in Table 4.

TABLE 4

| Toner | Amorphous | | Amorphous | | Crystalline | | |
|---|---|---|---|---|---|---|---|
| particle | polyester A | | polyester B | | polyester | | |
| No. | No. | Parts | No. | Parts | No. | Parts | SP_{A} − SP_{C} |
| 1 | 1 | 50.0 | 1 | 21.0 | 1 | 12.0 | 1.0 |
| 2 | 2 | 50.0 | 1 | 21.0 | 1 | 12.0 | 1.0 |
| 3 | 2 | 50.0 | 1 | 21.0 | 2 | 12.0 | 1.1 |
| 4 | 1 | 50.0 | 1 | 21.0 | 3 | 12.0 | 1.0 |
| 5 | 1 | 50.0 | 1 | 21.0 | 4 | 12.0 | 1.0 |
| 6 | 1 | 50.0 | 1 | 21.0 | 5 | 12.0 | 1.0 |
| 7 | 1 | 50.0 | 1 | 21.0 | 6 | 12.0 | 1.0 |
| 8 | 1 | 50.0 | 1 | 21.0 | 7 | 12.0 | 1.3 |
| 9 | 1 | 55.0 | 1 | 23.0 | 1 | 5.0 | 1.0 |
| 10 | 1 | 45.5 | 1 | 19.5 | 1 | 18.0 | 1.0 |
| 11 | 1 | 56.0 | 1 | 24.0 | 1 | 3.0 | 1.0 |
| 12 | 1 | 41.0 | 1 | 17.0 | 1 | 25.0 | 1.0 |
| 13 | 1 | 50.0 | 1 | 21.0 | 8 | 12.0 | 0.7 |
| 14 | 3 | 50.0 | 1 | 21.0 | 1 | 12.0 | 1.0 |
| 15 | 4 | 50.0 | 1 | 21.0 | 1 | 12.0 | 1.1 |
| 16 | 5 | 37.0 | 1 | 16.0 | 1 | 12.0 | 0.9 |
| 17 | 1 | 50.0 | 1 | 21.0 | 9 | 12.0 | 1.0 |
| 18 | 1 | 50.0 | 1 | 21.0 | 10 | 12.0 | 0.9 |
| 19 | 6 | 50.0 | 1 | 21.0 | 1 | 12.0 | 1.0 |
| 20 | 7 | 50.0 | 1 | 21.0 | 1 | 12.0 | 1.0 |
| 21 | 8 | 50.0 | 1 | 21.0 | 1 | 12.0 | 1.0 |
| 22 | 1 | 50.0 | 1 | 21.0 | 11 | 12.0 | 1.0 |
| 23 | 1 | 50.0 | 1 | 21.0 | 12 | 12.0 | 1.0 |
| 24 | 9 | 50.0 | 1 | 21.0 | 1 | 12.0 | 1.1 |
| 25 | 1 | 50.0 | 1 | 21.0 | 13 | 12.0 | 0.9 |
| 26 | 1 | 50.0 | 1 | 21.0 | 14 | 12.0 | 0.9 |
| 27 | 10 | 50.0 | 1 | 21.0 | 1 | 12.0 | 1.0 |
| 28 | 11 | 50.0 | 1 | 21.0 | 1 | 12.0 | 1.0 |
| 29 | 1 | 50.0 | 1 | 21.0 | 15 | 12.0 | 0.9 |
| 30 | 12 | 50.0 | 1 | 21.0 | 1 | 12.0 | 1.0 |
| 31 | 13 | 50.0 | 1 | 21.0 | 1 | 12.0 | 0.9 |
| 32 | 14 | 50.0 | 1 | 21.0 | 16 | 12.0 | 1.2 |

### Production Example of Toner 1

Toner particle 1:100 parts
Silica particle 1 (fumed silica with a number average diameter of 30 nm treated with silicone oil): 1.0 parts

The above materials were mixed using a Henschel mixer FM-10C model (manufactured by Mitsui Miike Machinery Co., Ltd.) at a number of revolutions of 30 s-1 for a rotation time of 10 min to obtain a toner 1.

### Production Example of Toners 2 to 32

Toners 2 to 32 were obtained by performing the production in the same manner as in the production example of the toner 1, except that the toner particles 2 to 32 were used.

Samples A and B were produced using the toners 1 to 32, and cross-sections were observed. The results are listed together in Table 5.

TABLE 5

| | Toner | Sample A | | Sample B | | | |
|---|---|---|---|---|---|---|---|
| Toner | particle | | S_{A}/ | | Aspect | S_{B}/ | D_{B} − |
| No. | No. | D_{A} | W_{C} | D_{B} | ratio | W_{C} | D_{A} |
| 1 | 1 | 30 | 0.2 | 40 | 3.5 | 0.6 | 10 |
| 2 | 2 | 25 | 0.1 | 30 | 3.0 | 0.3 | 5 |
| 3 | 3 | 20 | 0.05 | 25 | 2.5 | 0.2 | 5 |
| 4 | 4 | 30 | 0.1 | 40 | 3.5 | 0.3 | 10 |
| 5 | 5 | 30 | 0.3 | 40 | 3.5 | 0.7 | 10 |
| 6 | 6 | 25 | 0.05 | 30 | 3.0 | 0.2 | 5 |
| 7 | 7 | 35 | 0.4 | 45 | 4.0 | 0.8 | 10 |
| 8 | 8 | 50 | 0.5 | 70 | 5.0 | 0.9 | 20 |
| 9 | 9 | 30 | 0.2 | 40 | 3.5 | 0.5 | 10 |
| 10 | 10 | 30 | 0.2 | 45 | 3.5 | 0.6 | 15 |
| 11 | 11 | 25 | 0.1 | 30 | 4.0 | 0.3 | 5 |
| 12 | 12 | 35 | 0.3 | 55 | 3.0 | 0.7 | 20 |
| 13 | 13 | 20 | 0.05 | 30 | 3.5 | 0.2 | 10 |
| 14 | 14 | 20 | 0.1 | 40 | 2.3 | 0.5 | 20 |
| 15 | 15 | 60 | 0.3 | 70 | 5.2 | 0.5 | 10 |
| 16 | 16 | 10 | 0.1 | 15 | 2.2 | 0.2 | 5 |
| 17 | 17 | 80 | 0.3 | 100 | 6.0 | 0.7 | 20 |
| 18 | 18 | 80 | 0.3 | 100 | 6.0 | 0.7 | 20 |
| 19 | 19 | 80 | 0.3 | 100 | 6.0 | 0.7 | 20 |
| 20 | 20 | 80 | 0.3 | 100 | 6.0 | 0.7 | 20 |
| 21 | 21 | 30 | 0.2 | 40 | 3.5 | 0.6 | 10 |
| 22 | 22 | 30 | 0.2 | 40 | 3.5 | 0.6 | 10 |
| 23 | 23 | 8 | 0.01 | 15 | 2.0 | 0.05 | 7 |
| 24 | 24 | 110 | 0.3 | 150 | 8.0 | 0.8 | 40 |
| 25 | 25 | 100 | 0.3 | 150 | 9.0 | 0.8 | 50 |
| 26 | 26 | 100 | 0.3 | 150 | 9.0 | 0.8 | 50 |
| 27 | 27 | 100 | 0.3 | 150 | 9.0 | 0.8 | 50 |
| 28 | 28 | 100 | 0.3 | 150 | 9.0 | 0.8 | 50 |
| 29 | 29 | 150 | 0.5 | 200 | 12.0 | 0.9 | 50 |
| 30 | 30 | 150 | 0.5 | 200 | 12.0 | 0.9 | 50 |
| 31 | 31 | — | — | 200 | 12.0 | 0.5 | — |
| 32 | 32 | — | — | — | — | — | — |

### Production Example of Magnetic Core Particle 1

### Step 1 (Weighing/Mixing Step)

Fe₂O₃:62.7 parts by mass
MnCO₃: 29.5 parts by mass
Mg(OH)₂: 6.8 parts by mass
SrCO₃: 1.0 parts by mass

A ferrite raw material was weighed to obtain the above materials in the above composition ratio. After that, the mixture was then pulverized and mixed for 5 hours using a dry vibration mill with stainless steel beads having a diameter of ⅛ in.

### Step 2 (Pre-Firing Step)

The resulting pulverized substance was formed into pellets of 1 mm square by means of a roller compactor. The coarse powder was removed from the pellets using a vibrating sieve with a 3 mm aperture, and then the fine powder was removed by a vibrating sieve with a 0.5 mm aperture. After that, the powder was fired at 1000° C. for 4 hours under a nitrogen atmosphere (oxygen concentration: 0.01 vol %) using a burner-type firing furnace, thereby preparing a pre-fired ferrite. The composition of the calcined ferrite obtained is as follows.

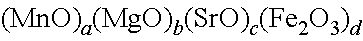

In the above formula, a=0.257, b=0.117, c=0.007, and d=0.393

### Step 3 (Pulverization Step)

After the pre-fired ferrite was pulverized to about 0.3 mm by a crusher, 30 parts by mass of water was added relative to 100 parts by mass of the pre-fired ferrite using zirconia beads having a diameter of ⅛ in., then pulverized by a wet ball mill, and the slurry was pulverized by a wet ball mill using alumina beads having a diameter of 1/16 in. for 4 hours, thereby obtaining a ferrite slurry (finely pulverized calcined ferrite).

### Step 4 (Granulation Step)

To the ferrite slurry, 1.0 part by mass of ammonium polycarboxylate as a dispersing agent and 2.0 parts by mass of polyvinyl alcohol as a binder were added relative to 100 parts by mass of the pre-fired ferrite, and spherical particles were granulated by means of a spray drier (manufacturer: Okawara Kakoki, Co., Ltd.). The obtained particles were adjusted in particle size and heated at 650° C. for 2 hours using a rotary kiln to remove organic components of the dispersing agent and the binder.

### Step 5 (Firing Step)

In order to control the firing atmosphere, the temperature was raised from room temperature to a temperature of 1300° C. in 2 hours in an electric furnace under a nitrogen atmosphere (oxygen concentration: 1.00 vol %), and the particle was fired at a temperature of 1150° C. for 4 hours. After that, the temperature was dropped to 60° C. over 4 hours, the atmosphere was returned from the nitrogen atmosphere to ambient air, and the sample was taken out at a temperature of 40° C. or lower.

### Step 6 (Sorting Step)

After the agglomerated particles were disintegrated, the low magnetic material was cut by magnetic sorting, and the coarse particles were removed by sieving with a sieve having an aperture of 250 μm, to obtain magnetic core particles 1 having a 50% grain size (D50) of 37.0 μm based on a volume distribution.

### Adjustment of Coating Resin 1

Cyclohexyl methacrylate monomer: 26.8 parts by mass
Methyl methacrylate monomer: 0.2 parts by mass
Methyl methacrylate macromonomer: 8.4 parts by mass
(Macromonomer with methacryloyl group at one terminal having weight-average molecular weight of 5000)
Toluene: 31.3 parts by mass
Methyl ethyl ketone: 31.3 parts by mass
Azobisisobutyronitrile: 2.0 parts by mass

Among the above materials, cyclohexyl methacrylate, methyl methacrylate, methyl methacrylate macromonomer, toluene, and methyl ethyl ketone were added to a four-necked separable flask equipped with a reflux condenser, a thermometer, a nitrogen inlet tube, and a stirrer, nitrogen gas was introduced to make the flask nitrogen atmosphere sufficiently, then the flask was warmed to 80° C., azobisisobutyronitrile was added, and the mixture was refluxed for 5 hours to cause polymerization.

Hexane was injected to the obtained reaction product to precipitate a copolymer, the precipitate was filtered off, and then dried under vacuum to obtain a coating resin 1. 30 parts by mass of the obtained coating resin 1 was dissolved in 40 parts by mass of toluene and 30 parts by mass of methyl ethyl ketone to obtain a polymer solution 1 (solid content: 30 mass %).

### Preparation of Coating Resin Solution 1

Polymer Solution 1 (resin solids concentration: 30%): 33.3 parts by mass
Toluene: 66.4 parts by mass
Carbon black (Regal 330, manufactured by Cabot Corp.): 0.3 parts by mass (Primary particle size: 25 nm, nitrogen adsorption specific surface area: 94 m²/g, and DBP oil absorption: 75 mL/100 g)

The above material was dispersed for one hour using a paint shaker with zirconia beads of 0.5 mm diameter. The resulting dispersion was filtered through a 5.0 μm membrane filter to obtain a coating resin solution 1.

### Production Example of Magnetic Carrier 1

### Resin Coating Step

The coating resin solution 1 was placed in a vacuum deaeration-type kneader maintained at room temperature so that the amount thereof be 2.5 parts by mass as a resin component relative to 100 parts by mass of the magnetic core particle 1. After being placed, the mixture was stirred at a rotating speed of 30 rpm for 15 minutes, and the solvent was evaporated to a certain level or more (80 mass %). After that, the temperature was raised to 80° C. while mixing under reduced pressure, toluene was distilled off over 2 hours, and then cooled. Low magnetic field products were removed from the resulting magnetic carrier through magnetic sorting, then the magnetic carrier obtained was allowed to pass through a sieve with 70 μm aperture, and classified by an air force classifier to obtain a magnetic carrier 1 with a 50% grain size (D50) based on volume distribution of 38.2 μm.

### Production Example of Two-Component Developer 1

The toners 1 to 32 and the magnetic carrier 1 were respectively mixed at 0.5 s⁻¹ using a V-type mixer (V-10 type: Tokuju Corp.) for a rotation time 5 min so that a toner concentration was 8.0 mass % to obtain two-component developers 1 to 32.

### Example 1

### Low-Temperature Fixability

Evaluation was performed using the two-component developer 1.

A modified digital commercial printing printer (imageRUNNER ADVANCE C5560, manufactured by Canon Inc.) was used as an image forming apparatus, and the two-component developer 1 was placed in a cyan developing device. The modification of the device included changing it such that the fixation temperature, the process speed, the DC voltage VDC of the developer bearing member, the charging voltage VD of the electrostatic latent image bearing member, and the laser power could be freely set. For the image output evaluation, an FFh image (solid image) with a desired image ratio was output. VDC, VD, and laser power were adjusted so that the amount of the toner deposited on the FFh image on the paper reached a desired amount, and the low-temperature fixability was evaluated.

FFh is a hexadecimal value representing 256 gradations, with 00 h being the first gradation (white background) of the 256 gradations and with FFh being the 256th gradation (solid area) of the 256 gradations.

Evaluation was performed on the basis of the following evaluation method, and the results are shown in Table 6.
Paper: GFC-081 (81.0 g/m²) (commercially available from Canon Marketing Japan Inc.)
Amount of toner deposited on paper: 0.70 mg/cm² (adjusted by the DC voltage VDC of the developer bearing member, the charging voltage VD of the electrostatic latent image bearing member, and the laser power)
Image for evaluation: A 2 cm×5 cm image was placed in the center of the A4 paper sheet.
Test environment: low temperature and low humidity environment: temperature 15° C./humidity 10% RH (hereinafter referred to as “L/L”)
Fixation temperature: 140° C.
Process speed: 320 mm/sec

The evaluation images were output, and the low-temperature fixability was evaluated. The value of the rate of image density decrease was used as an evaluation index for low-temperature fixability.

The rate of image density decrease was measured using an X-Rite color reflection densitometer (500 series: manufactured by X-Rite Inc.), and first, the image density of the center was measured. Next, a load of 4.9 kPa (50 g/cm²) was applied to the part where the image density was measured, the fixed image was subjected to friction (five times back and forth) with lens-cleaning paper, and the image density was measured again. Then, the rate of decrease in image density before and after friction was calculated using the following expression. The rate of decrease in image density obtained was evaluated according to the following evaluation criteria. If the evaluation fell within the range of AA to C, the evaluation was judged to be satisfactory.

$$Rate of decrease in image density = [ ( image density before friction ) - ( image density after friction ) ] / ( image density before friction ) \times 100$$

### (Evaluation Criteria)

AA: The rate of decrease in image density was less than 1.0%
A: The rate of decrease in image density was 1.0% or more and less than 3.0%
B: The rate of decrease in image density was 3.0% or more and less than 5.0%
C: The rate of decrease in image density was 5.0% or more and less than 8.0%
D: The rate of decrease in image density was 8.0% or more
   Charge Retention Property under High-Temperature and High-Humidity Environment
Paper: GFC-081 (81.0 g/m²) (Canon Marketing Japan Inc.)
Amount of toner deposited on paper: 0.35 mg/cm² (adjusted by the DC voltage V_{DC} of the developer bearing member, the charging voltage VD of the electrostatic latent image bearing member, and the laser power)
Image for evaluation: A 2 cm×5 cm image was placed in the center of the A4 paper sheet.
Fixation test environment: high temperature and high humidity environment: temperature 30° C./humidity 80% RH (hereinafter referred to as “H/H”)
Process speed: 377 mm/sec

The triboelectric charge quantity of the toner was calculated by sucking and collecting the toner on the electrostatic latent image bearing member using a cylindrical metal tube and a cylindrical filter. Specifically, the triboelectric charge quantity of the toner on the electrostatic latent image bearing member was measured by a Faraday cage.

The Faraday cage is a coaxial double cylinder that insulates the inner and outer cylinders. When a charged body with an electric charge amount Q is inserted into the inner cylinder, it is as if a metallic cylinder with an electric charge amount Q exists by electrostatic induction. The induced charge amount was measured by an electrometer (Keithley 6517A manufactured by Keithley Instruments), and the electric charge amount Q (mC) was divided by the mass M (kg) of toner in the inner cylinder (Q/M) was defined as the triboelectric charge quantity of the toner.

$$Triboelectric charge quantity ( mC / kg ) of toner = Q / M$$

First, the evaluation image was formed on the electrostatic latent image bearing member, and before the image was transferred onto the intermediate transfer member, the rotation of the electrostatic latent image bearing member was stopped, the toner on the electrostatic latent image bearing member was sucked and collected using a cylindrical metal tube and a cylindrical filter, and the [initial Q/M] was measured.

Subsequently, the developing device was left to stand in the evaluating device in an H/H environment for 2 weeks, and then the same operation as before the standing was conducted, and the amount of electric charge Q/M (mC/kg) per unit mass on the electrostatic latent image bearing member after standing was measured. The Q/M per unit mass on the initial electrostatic latent image bearing member mentioned above was taken as 100%, and the charge retention ratio ([Q/M after standing]/[initial Q/M]×100) per unit mass on the electrostatic latent image bearing member after standing was calculated and determined based on the following criteria. If the evaluation fell within the range of A to C, it was judged to be good.

### (Evaluation Criteria)

A: Charge retention rate of 90% or more
B: Charge retention rate of 85% or more and less than 90%
C: Charge retention rate of 80% or more and less than 85%
D: Charge retention rate of less than 80%

### Resistance to Sheet Adhesion

Paper: CS-680 (A4 sheet, 68.0 g/m²) (manufactured by Canon Marketing Japan Inc.)
Amount of toner deposited: 1.20 mg/cm²
Evaluation image: A 100 cm² (10 cm×10 cm) image was placed in the center of the A4 paper sheet.
Fixation test environment: low temperature and low humidity environment: 15° C./10% RH (hereinafter referred to as “L/L”)
Process speed: 320 mm/sec
Fixation temperature: 140° C.

Using the image forming apparatus described above, two fixed images were output under the conditions described above, and the output articles were superposed so that the printed portions of the output articles were brought into contact with each other.

A bundle of paper sheets (CS-680, 500 sheets) was further stacked on two sheets of the output articles, and the output articles and the bundle of paper sheets were placed in a constant temperature bath set at 30° C. and 80% RH, allowed to stand for one hour, then the temperature in the constant temperature bath was reset to the evaluation conditions described below, and allowed to stand for 10 hours.

Next, the two output articles were taken out from the thermostatic container, allowed to cool for 1 hour, and then examined to see whether they adhered when peeled off. If the evaluation fell in the range of A to C, it was judged to be good.

### Evaluation Criteria

A: The output articles do not adhere to each other in a constant temperature bath at 60° C.
B: The output articles do not adhere to each other in a constant temperature bath at 55° C.
C: The output articles do not adhere to each other in a constant temperature bath at 50° C.
D: The output articles adhere to each other in a constant temperature bath at 50° C., and are torn if the two outputs are strongly peeled off

### Resistance to Folding

Paper: OK Topcoat Plus
Toner amount deposited: 1.2 mg/cm²
Image for evaluation A solid image is printed on the entire surface of an A4 paper sheet
Fixation test environment: under a normal temperature and normal humidity environment at 25° C. and 50% RH (hereinafter referred to as “N/N”)
Process speed: 132 mm/sec
Fixation temperature: 150° C.

A single fixed image was output using the image forming apparatus described above under the conditions described above.

The output article was placed in a constant-temperature ventilator set to 50° C., allowed to stand for 72 hours, and then the taken-out sample was allowed to cool in a N/N environment for 1 hour, and then subjected to a mandrel test.

In the mandrel test device, a cylindrical mandrel bending tester (manufactured by COTEC Corp.) was used. A mandrel with a diameter of @ 2 mm was used. The image is placed in the mandrel tester, and the image is folded 180°. A 200 g weight is placed on a silbon paper and the folded portion is rubbed, and then the image is peeled off the paper. The image portion that has been peeled is read at three positions by PIAS (manufactured by Quality Engineering Associates Inc.), and the area of the bent portion that has not been peeled among the folded portion is digitized by an image processing software ImageJ to calculate.

An analysis method using ImageJ will be explained. An image to be evaluated is opened in ImageJ and converted the image to an 8-bit form. Then, a threshold processing is performed to separate portions where peeling has not occurred from those where peeling does occur. Through rectangle processing, a peel-off portion was added to the designated range of 500 pixels in width×70 pixels in height, and the analysis was performed. As such, the (total area): (area A) at the peeled portion is calculated.

Next, the designated range is moved to a region in which peeling has not occurred, and the (total area): (area B) of a region where peeling has not occurred is calculated. Then, the ratio of the area in which peeling has not occurred was digitized as area B/(area A+area B).

The value obtained as described above was used to indicate the resistance to folding of printed images, and the value was evaluated according to the following criteria. If the evaluation was A to C, it was judged to be good.

### (Evaluation Criteria)

A: Resistance to folding is 90% or more
B: Resistance to folding is less than 90% and 80% or more
C: Resistance to folding is less than 80% and 70% or more
D: Resistance to folding is less than 70%

### Examples 2 to 22 and Comparative Examples 1 to 10

The evaluation was conducted in the same manner as in Example 1, except that the two-component developer used in the evaluation was replaced with the two-component developer listed in Table 6. The evaluation results are presented in Table 6.

TABLE 6

| | | | Toner characteristics evaluation | | | |
|---|---|---|---|---|---|---|
| | Toner | Two-component | Low-temperature | Charge retention | Resistance to | Resistance to |
| | No. | developer No. | fixability | properties | sheet adhesion | folding |
| Example 1 | 1 | 1 | A | B | B | B |
| Example 2 | 2 | 2 | A | B | C | B |
| Example 3 | 3 | 3 | AA | C | C | A |
| Example 4 | 4 | 4 | A | C | C | B |
| Example 5 | 5 | 5 | A | A | A | C |
| Example 6 | 6 | 6 | A | C | C | A |
| Example 7 | 7 | 7 | B | A | A | C |
| Example 8 | 8 | 8 | B | B | A | C |
| Example 9 | 9 | 9 | C | A | B | A |
| Example 10 | 10 | 10 | A | C | B | C |
| Example 11 | 11 | 11 | C | A | B | A |
| Example 12 | 12 | 12 | AA | C | A | C |
| Example 13 | 13 | 13 | A | C | C | A |
| Example 14 | 14 | 14 | A | C | C | C |
| Example 15 | 15 | 15 | B | C | A | C |
| Example 16 | 16 | 16 | AA | A | C | A |
| Example 17 | 17 | 17 | C | C | A | C |
| Example 18 | 18 | 18 | C | C | A | C |
| Example 19 | 19 | 19 | C | C | A | C |
| Example 20 | 20 | 20 | C | C | A | C |
| Example 21 | 21 | 21 | A | B | B | C |
| Example 22 | 22 | 22 | A | B | B | C |
| Comparative | 23 | 23 | AA | C | D | A |
| Example 1 | | | | | | |
| Comparative | 24 | 24 | D | D | A | D |
| Example 2 | | | | | | |
| Comparative | 25 | 25 | D | D | A | D |
| Example 3 | | | | | | |
| Comparative | 26 | 26 | D | D | A | D |
| Example 4 | | | | | | |
| Comparative | 27 | 27 | D | D | A | D |
| Example 5 | | | | | | |
| Comparative | 28 | 28 | D | D | A | D |
| Example 6 | | | | | | |
| Comparative | 29 | 29 | D | D | A | D |
| Example 7 | | | | | | |
| Comparative | 30 | 30 | D | D | A | D |
| Example 8 | | | | | | |
| Comparative | 31 | 31 | AA | D | D | D |
| Example 9 | | | | | | |
| Comparative | 32 | 32 | AA | D | D | A |
| Example 10 | | | | | | |

The present disclosure provides a toner that exhibits excellent low-temperature fixability and charge retention properties, suppresses sheet adhesion immediately after fixing, and does not easily lose the resistance to folding, even during long-term storage.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198410, filed Nov. 13, 2024, which is hereby incorporated by reference herein its entirety.

What is claimed is:

1. A toner comprising a toner particle that comprises an amorphous polyester resin and a crystalline polyester resin,
the amorphous polyester resin comprising a modified amorphous polyester resin having at least one linear alkyl compound condensed to a terminal, selected from the group consisting of linear C16-24 aliphatic monocarboxylic acids and linear C16-24 aliphatic monoalcohols;
the crystalline polyester resin comprising a modified crystalline polyester resin having at least one linear alkyl compound condensed to a terminal, selected from the group consisting of linear C16-24 aliphatic monocarboxylic acids and linear C16-24 aliphatic monoalcohols; and
when a cross-section of a sample A obtained by melting the toner at 150° C. and then cooling the toner to 25° C. at a rate of 100° C./min is observed using a transmission electron microscope, and a number average of the long axis lengths of crystals of the crystalline polyester resin observed on the cross section is taken as D_{A} (nm), and
when a cross-section of a sample B obtained by allowing the sample A to stand at 50° C. for 72 hours is observed using a transmission electron microscope, and a number average of the long axis lengths of crystals of the crystalline polyester resin observed in the cross-section is taken as D_{B} (nm),
the D_{A} and the D_{B} satisfying expressions (1) and (2) below:
$$10 nm \leq {D}_{A} \leq 100 nm \qquad ( 1 )$$
$$1 nm \leq {D}_{B} - {D}_{A} \leq 20 nm . \qquad ( 2 )$$

2. The toner according to claim 1, wherein the D_{A} and the D_{B} satisfy expressions (3) and (4) below:
$$10 nm \leq {D}_{A} \leq 50 nm \qquad ( 3 )$$
$$20 nm \leq {D}_{B} \leq 70 nm . \qquad ( 4 )$$

3. The toner according to claim 1, wherein, when the cross-section of the sample B is observed, the crystals of the crystalline polyester resin observed in the cross-section have an average aspect ratio of 2.5 to 5.0.

4. The toner according to claim 1, wherein when an SP value of the modified amorphous polyester resin is taken as SP_{A} (cal/cm³)^{0.5}, and an SP value of the modified crystalline polyester resin is taken as SP_{C} (cal/cm³)^{0.5}, the SP_{A} and the SP_{C} satisfy expression (5) below:
$$0.8 \leq {SP}_{A} - {SP}_{C} \leq 1.2 . \qquad ( 5 )$$

5. The toner according to claim 1, wherein the crystalline polyester resin has a content ratio W_{C} of 5.0 to 20.0 mass % based on the mass of the toner particle.

6. The toner according to claim 1, wherein
when a content ratio of the crystalline polyester resin based on the mass of the toner particle is taken as W_{C} (mass %), and
an average area ratio of crystals of the crystalline polyester resin in an area of an observation range is taken as S_{A} (area %) upon observation of the cross section of the sample A using a transmission electron microscope,
the W_{C} and the S_{A} satisfy expression (6) below:
$$0.1 \leq {S}_{A} / {W}_{C} \leq 0.6 . \qquad ( 6 )$$

7. The toner according to claim 1, wherein
when a content ratio of the crystalline polyester resin based on the mass of the toner particle is taken as W_{C} (mass %), and
an average area ratio of crystals of the crystalline polyester resin in an area of an observation range is taken as S_{B} (area %) upon observation of a cross section of the sample B using a transmission electron microscope,
the W_{C} and the S_{B} satisfy expression (7) below:
$$0.3 \leq {S}_{B} / {W}_{C} \leq 0.8 . \qquad ( 7 )$$

8. The toner according to claim 1 wherein the modified crystalline polyester resin has a weight-average molecular weight of 15000 to 25000.

9. The toner according to claim 1, wherein the linear alkyl compound condensed to a terminal of the modified amorphous polyester resin has a greater number of carbons than the linear alkyl compound condensed to a terminal of the modified crystalline polyester resin.

10. The toner according to claim 1, wherein the linear alkyl compound condensed to a terminal of the modified amorphous polyester resin is stearic acid, and
the linear alkyl compound condensed to a terminal of the modified crystalline polyester resin is behenic acid.

11. The toner according to claim 1, wherein the modified crystalline polyester resin has a monomer unit corresponding to ethylene glycol and a monomer unit corresponding to dodecanedioic acid.

12. The toner according to claim 1, wherein a proportion of terminals at which the linear alkyl compound is condensed among molecular chain terminals of the modified amorphous polyester resin is at least 0.5 mol % and less than 25 mol %, and
a proportion of terminals at which the linear alkyl compound is condensed among molecular chain terminals of the modified crystalline polyester resin is 15 to 75 mol %.
